(19) United States
(12) Patent Application Publication
(10) Pub. No.: US 2024/0016147 A1
(43) Pub. Date: Jan. 18, 2024

(54) AGRICULTURAL BIOPOLYMER COATING PLATFORM

(71) Applicants: AgroSpheres, Inc., Charlottesville, VA (US); Joseph FRANK, Charlottesville, VA (US); Sepehr ZOMORODI, Charlottesville, VA (US)

(72) Inventors: Joseph FRANK, Charlottesville, VA (US); Sepehr ZOMORODI, Charlottesville, VA (US); Sergio Madrigal CARBALLO, Charlottesville, VA (US); Ameer Hamza SHAKEEL, Charlottesville, VA (US); Payam POURTAHERI, Charlottesville, VA (US)

(21) Appl. No.: 18/248,235

(22) PCT Filed: Oct. 8, 2021
(86) PCT No.: PCT/US2021/054259

§ 371 Date: Apr. 6, 2023

Related U.S. Application Data
(60) Provisional application No. 63/090,017, filed on Oct. 9, 2020.

(51) Int. Cl. A01N 25/28; A01N 25/30; A01N 25/04; A01N 65/22; A01N 31/16

(52) U.S. Cl. CPC A01N 25/28; A01N 25/30; A01P 3/00; A01N 65/22; A01N 31/16; A01N 25/04

(57) ABSTRACT

The present disclosure provides biodegradable, bioactive biopolymer nanocoating platforms, compositions thereof, and methods for making and producing the biopolymer nanocoating platforms. The present disclosure also provides various agricultural applications of the biodegradable, bioactive biopolymer nanocoating platforms.

### CROSS-REFERENCE TO RELATED APPLICATIONS

This application claims the benefit of priority to U.S. Provisional Application No. 63/090,017 filed on Oct. 9, 2020, which is hereby incorporated by reference in its entirety.

### FIELD OF THE DISCLOSURE

The present disclosure is generally directed to biodegradable, bioactive biopolymer nanocoating platforms, compositions thereof, and methods for making and producing the platforms. Also, disclosed herein are various applications of a biodegradable, bioactive biopolymer nanocoating molecule for agricultural use.

### BACKGROUND OF THE DISCLOSURE

Along with rapid growth of world population, global efforts to increase future crop harvest and food production are required to meet future challenges. Agricultural active ingredients, such as pesticides, insecticides, herbicides, fungicides, nematicides, fertilizers, and growth regulators, play a significant role in food production to prevent large crop losses. However, there is a continuing concern about overuse of agricultural active ingredients and their negative effects on human health and the surrounding environment. Especially, uncontrolled use of agrochemicals becomes a potential threat to humans due to their toxicity and can contaminate soil and water to threaten existence of other living species.

On the other hand, agricultural products such as tubers, fruits, fresh vegetables, seeds and grains are subject to deterioration and spoilage during storage and transit due to a number of pathogen as well as environmental condition such as heat, humidity, and UV radiation. Agricultural product producers have been suffered over decades from losses in quality and quantity due to damage of fresh produces. Unsurprisingly, customers have been accustomed to products that are more or less spoiled products.

Agricultural product supplies could be augmented if there are solutions of increasing crop production with controlled use of agricultural actives and minimizing crop losses. Thus, there is an unmet need to develop a new surface-coating system for stabilizing agricultural active ingredients and controlling release of the ingredients, as well as protecting various agricultural products from environmental hazards.

### SUMMARY OF THE DISCLOSURE

The present disclosure provides a biodegradable, bioactive multilayered nanocoating platform, which can act as a functional coating for protecting and stabilizing agricultural active ingredients such as pesticides, insecticides, herbicides, fungicides, nematicides, fertilizers, and growth regulators, thereby promoting controlled release thereof. Also, the platform taught in this disclosure is designed for functionally coating agricultural products, such as tubers, fruits, fresh vegetables, grains and seeds, thereby imposing environmental stability from UV radiation, heat, humidity and/or protection from pests, such as insects, fungus and pathogens among many others.

The present disclosure provides a coating platform for agricultural use, comprising a layer-by-layer assembly, wherein the layer-by-layer assembly comprises at least two biopolymers. In some embodiments, said two biopolymers are selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof. In some embodiments, said biopolymers are assembled by a noncovalent bond. In some embodiments, one selected biopolymer can form said layer-by-layer assembly comprising the selected biopolymer by said noncovalent bond. In some embodiments, said platform comprises an agricultural agent within the platform.

In some embodiments, a first biopolymer is chitosan. In some embodiments, a second biopolymer is alginate, dextran sulfate, or sulfonated lignin. In some embodiments, said at least two biopolymers comprise chitosan and alginate. In some embodiments, said at least two biopolymers comprise chitosan and dextran sulfate.

In some embodiments, said platform is stabilized by an addition of a stabilizing agent. In some embodiments, said stabilizing agent is selected from a pH regulator, a non-ionic surfactant and a crosslinker agent. In some embodiments, said pH regulator is selected from Phosphate buffer saline (PBS), ammonium buffer, acetate buffer, citrate buffer, and carbonate buffer. In some embodiments, said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®. In some embodiments, said crosslinker agent is selected from Genipin, calcium chloride, tripolyphosphate, proanthocyanidins, epigallocatechin gallate, and glucosaminoglycans.

In some embodiments, said agricultural agent is an agrochemical, a biologically active agent, or an agricultural product. In some embodiments, said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent. In some embodiments, said agricultural product is selected from a seed, a grain, a fruit, a seedling, a leafy vegetable, a fresh-cut plant produce, and an edible part of a plant.

In some embodiments of the platform taught herein, said agrochemical or said biologically active agent is loaded into a microparticle. In some embodiments, said microparticle comprises a minicell or a colloidal carrier. In some embodiments, said colloidal carrier is selected from a liposome, a noisome, a microsphere, a nanosphere, and an emulsion.

In some embodiments of the platform taught herein, said layer-by-layer assembly comprises at least 3, 4, 5, 6, or more layers. In some embodiments, said coating platform forms a macromolecular structure. In some embodiments, said macromolecular structure is a thin film, a nanoparticle, a molecular aggregate, a colloidal suspension, or a microcapsule. In some embodiments, the platform is in the form of an emulsion, a film, a spray coating, a dip coating, a dissolution, or a combination thereof.

The present disclosure provides a coating platform for agricultural use comprising a layer-by-layer assembly, wherein the layer-by-layer assembly comprises at least two polymers. In some embodiments, a first polymer comprises a cationic polymer and a second polymer comprises an anionic polymer. In some embodiments, said first and second polymers are assembled by a noncovalent bond. In some embodiments, said layer-by-layer assembly is formed by alternating layers of at least one cationic polymer and at least one anionic polymer. In some embodiments, said platform comprises an agricultural agent within the platform. In some embodiments, said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride). In some embodiments, said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate. In some embodiments, said cationic polymer is chitosan. In some embodiments, said anionic polymer is alginate, dextran sulfate, or sulfonated lignin. In some embodiments, said platform is stabilized by an addition of a stabilizing agent taught herewith. In some embodiments, said agricultural agent is an agrochemical, a biologically active agent, or an agricultural product taught herewith. In some embodiments, said agrochemical or said biologically active agent is loaded into a microparticle taught herewith. In some embodiments, said layer-by-layer assembly comprises at least 3, 4, 5, 6, or more layers. In some embodiments, said coating platform forms a macromolecular structure taught herewith.

The present disclosure provides a multilayered biopolymer composition for agricultural use, comprising: a. a first biopolymer which is chitosan, b. a second biopolymer which is alginate, dextran sulfate, or sulfonated lignin, wherein said two biopolymers are assembled by a noncovalent bond, and wherein said composition comprises an agricultural agent within the composition. In some embodiments, said platform is stabilized by an addition of a stabilizing agent taught herewith. In some embodiments, said agricultural agent is an agrochemical, a biologically active agent, or an agricultural product taught herewith. In some embodiments, said agrochemical or said biologically active agent is loaded into a microparticle taught herewith. In some embodiments of the multilayered biopolymer composition, said layer-by-layer assembly comprises at least 2, 3, 4, 5, 6, or more layers. In some embodiments, said coating platform forms a macromolecular structure taught herewith.

The present disclosure provides a composition comprising an agricultural agent coated by a layer-by-layer assembly comprising at least two biopolymers selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof. In some embodiments, said platform is stabilized by an addition of a stabilizing agent taught herewith. In some embodiments, said agricultural agent is an agrochemical, a biologically active agent, or an agricultural product taught herewith. In some embodiments, said agrochemical or said biologically active agent is loaded into a microparticle taught herewith.

Provided herewith is a method of preparing a multilayered polymer composition for encapsulation and delivery of an agricultural agent, said method comprising the steps of: a) providing a pair of polymers, wherein a first polymer comprises a cationic polymer and a second polymer comprises an anionic polymer; b) allowing layer-by-layer assembly of said first polymer and said second polymer; c) optionally, adding a stabilizing agent to said layer-by-layer assembly, and d) coating the agricultural agent with said layer-by-layer assembly; wherein said two polymers are assembled by a noncovalent bond. In some embodiments, said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride). In some embodiments, said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate. In some embodiments, said cationic polymer comprise chitosan. In some embodiments, said anionic polymer comprise alginate, dextran sulfate, or sulfonated lignin. In some embodiments, said stabilizing agent is selected from a pH regulator, a non-ionic surfactant and a crosslinker agent taught herewith. In some embodiments, said agricultural agent is an agrochemical, a biologically active agent, or an agricultural product taught herewith. In some embodiments of the method, said agrochemical or said biologically active agent is loaded into a microparticle taught herewith. In some embodiments, said multilayered polymer composition comprises at least 2, 3, 4, 5, 6, or more layers. In some embodiments of the method, the coating of the agricultural agent with the layer-by-layer assembly increases stability of the agricultural agent from an environmental hazard. In some embodiments, the coating of the agricultural agent with the layer-by-layer assembly promotes controlled release of the agricultural agent. In some embodiments, said polymer-coated agricultural agent enhances a shelf-life of the agricultural product.

Provided herewith is a method of producing a polymer-coated agricultural agent, the method comprising the steps of: a) providing an agricultural agent; b) contacting said agricultural agent with a cationic polymer; c) contacting said agricultural agent with an anionic polymer; thereby producing said polymer-coated agricultural agent. In some embodiments of the method, further comprising the step of: d) adding a stabilizing agent to said polymer-coated agricultural agent. In some embodiments, steps b) and c) are repeated to encapsulate said agricultural agent with a multilayer of said polymers.

### BRIEF DESCRIPTION OF THE FIGURES

FIG. 1 illustrates the mechanism for fabrication of agricultural biopolymer coating platform, starting with the formation of a stationary state, corresponding to a biopolymer complex arranged by reversible non-covalent interactions, followed by a stabilized self-assembled macrostructure after treatment with stabilizing agent(s), depicting in irreversible non-covalent intermolecular interactions.

FIG. 2 illustrates the layer by-layer self-assembly mechanism for tailoring non-covalent interactions between naturally occurring polymers (including biopolymers), allowing the formation of macromolecular arrangements for different applications in agriculture. Each new polymer layer is added onto the previously assembled biopolymer layer following the mechanisms described in FIG. 1.

FIG. 3 illustrates variation in zeta-potential upon addition of naturally occurring biopolymers (polysaccharides) layers via layer-by-layer self-assembly to a plant surface layer (L). Two biopolymer systems were tested; (●) corresponds to chitosan biopolymer (CHT) and Alginate biopolymer (ALG), whereas (x) corresponds to chitosan biopolymer (CHT) and Dextran Sulfate biopolymer (DXS). PS: polysaccharide biopolymer selected from (●) ALG: alginate layer or (x) DXS: dextran sulfate layer. From one biopolymer layer to the plat surface layer (i.e. L-CHT) up to eight layers to the plat surface layer (i.e. L-(CHT-PS)₄: 4 CHT biopolymer layers and 4 PS biopolymer layers in alteration) were assembled and tested.

FIG. 4 illustrates three featured agricultural applications for the biopolymer coating platform based on layer by-layer self-assembly of naturally occurring biopolymers. I. Microencapsulation agent: microencapsulated agricultural active ingredients can be encapsulated by the biopolymer coating platform and stabilized by crosslinker. II. Surface coating agent: agricultural solid microparticle containing agricultural agents can be coated by the biopolymer coating platform by self-assembly. III. Bioactive, edible preserving nanocoating: agricultural product or produce can be coated by the biopolymer coating platform by self-assembly.

FIG. 5 illustrates the mechanism for controlled release of agricultural active ingredients from biopolymer coating platform/multilayered biopolymer composition.

FIGS. 6A-6B illustrate surface analysis of liposomal formulation coated by the biopolymer coating platform. Atomic Force Microscopy (AFM) imaging of biopolymer-coated liposomes shows homogeneous spherical shapes and low particle aggregation (FIG. 6A). Fluorescent microscopy imaging of liposomes coated by fluorescently labeled biopolymer layer (i.e. fluorescently labeled CHT layer) is presented in FIG. 6B. The scale bar on FIG. 6B represents 200 nm. Dashed arrows indicate the presence of un-coated liposomes (smaller size close to 100 nm) and solid arrows indicate the location of fluorescent-chitosan coated liposomes (bigger size due to biopolymer coating, close to 200 nm)

FIG. 7 illustrates variations on average nanoparticle (i.e. liposome) size upon addition of successive coating layers of biopolymers via layer-by-layer self-assembly. L: liposome core, CHT: chitosan layer, PS: polysaccharide biopolymer selected from (●) ALG: alginate layer or (x) DXS: dextran sulfate layer. From one biopolymer layer to the liposome (i.e. L-CHT) up to eight layers to the liposome (i.e. L-(CHT-PS)₄: 4 CHT biopolymer layers and 4 PS biopolymer layers in alteration) were assembled and tested.

FIG. 8 illustrates variations on surface tension of core liposome formulation upon addition of successive coating layers of biopolymers via layer-by-layer self-assembly. L1: a single biopolymer layer added to liposome. L1+L2: two biopolymer layers added to liposome. L1+L2+L3: three biopolymer layers added to liposome. L1+L2+L3+L4: four biopolymer layers added to liposome.

FIG. 9 illustrates effects of the biopolymer coating on the release profiles of model agricultural active ingredient loaded into core liposome formulation over time. L: liposomes un-coated, CHT: chitosan biopolymer layer, DXS: dextran sulfate biopolymer layer, ALG: alginate biopolymer layer. L: liposome without biopolymer layer(s); L-(CHT-DXS)₂: two biopolymer layers (one CHT layer and one DXS layer in alteration) to the liposome; L-(CHT-DXS)₄: four biopolymer layers (2 CHT layers and 2 DXS layers in alteration) to the liposome; L-(CHT-ALG)₂: two biopolymer layers (one CHT layer and one ALG layer in alteration) to the liposome; L-(CHT- ALG)₄: four biopolymer layers (2 CHT layers and 2 ALG layers in alteration) to the liposome.

FIGS. 10A-10B illustrate percentage release profiles for minicell-encapsulated Eugenol from the biopolymer coating platform coated (chitosan biopolymer 0.1 and 1.0% w/v), against from the platform uncoated, in two different release medium, aqueous ethanol 10% v/v (FIG. 10A) and Tween 80 emulsifier 0.25% v/v (FIG. 10B). Eugenol: Eugenol neither loaded into minicell nor coated with biopolymer coating platform; MC-Eug: Eugenol loaded into minicells, but not coated with biopolymer coating platform; MC-Eug CHT 0.1%: Eugenol loaded into minicells and coated with biopolymer coating platform by CHT 1.0% (single CHT layer); Eugenol loaded into minicells and coated with biopolymer coating platform by CHT 1.0% (single CHT layer).

FIG. 11 illustrates mass balance of Eugenol content (mg/mL) in minicells and the single biopolymer coating platform (i.e. chitosan-coated minicell) after release experiments in Tween 80 emulsifier 0.25% v/v.

FIG. 12 illustrates the mechanism for controlled release of agricultural active fertilizers loaded into microparticles that are coated by biopolymer layer (s), where the different release profiles will be obtained due to differences in degradation processes occurring on the alternating biopolymer layers due to physical, chemical or enzymatic mechanisms.

FIG. 13 illustrates pictures showing the physical appearance of fertilizer solutions loaded into minicell-based microcapsules that are coated with alternating layers of biopolymers. A. single (1×) biopolymer layer, B. two (2×) biopolymer layers, C. three (3×) biopolymer layers, D. four (4×) biopolymer layers and E. five (5×) biopolymer layers.

FIG. 14 illustrates percentage release profiles of fertilizer solution loaded into minicell-based microcapsules formulated with increasing biopolymer coating layers, up to 5× biopolymer layers.

FIG. 15 illustrates the mechanism for protecting functional coating of agricultural products and seeds by biopolymer nanocoating technology.

FIG. 16 illustrates dynamic release of thyme oil (100 mg) encapsulated into minicells (MC) and coated with alternating layers of biopolymers; CHT and ALG. CHT: chitosan 10 mg/mL; ALG: alginate 10 mg/mL. Load: ethanol extract corresponding to the original concentration of thyme oil in each formulation. Cycle 1: released thyme oil after first cycle of extraction with tap water. Cycle 2: released thyme oil after second cycle of extraction with tap water. Extract: released thyme oil after extraction cycle with ethanol. Total: mass balance comparing original thyme oil content and total thyme oil released (cycle 1+cycle 2+extract).

FIG. 17 shows effects of biopolymer coating on preventing volatilization of active ingredient (thyme oil) encapsulated into minicells.

FIG. 18 shows fungicide efficacy of (i) minicells encapsulated thyme oil (AGS 1) and (ii) biopolymer coated minicells encapsulating thyme oil (AGS 2) against powdery mildew on sweetened hemp cultivar in the greenhouse. Selected positive and negative treatments were included for illustrative purposes. Pictures were taken after completion of the greenhouse trial held.

### DETAILED DESCRIPTION

### Definition

The term “a” or “an” refers to one or more of that entity, i.e. can refer to a plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

As used herein, the terms “applying” or “application” of an agricultural agent taught herein to a subject includes any route of introducing or delivering to a subject a compound, a composition, an agent, a formulation, a platform or a system to perform its intended function. Applying or application includes self-application, application by another, or application with other ingredients or products. In some embodiments, the agricultural agent is loaded into a minicell. In further embodiments, the agricultural agent loaded into a minicell and coated with at least one biopolymer layer taught herein. In some embodiments, the agricultural agent is directly coated with at least one biopolymer layer taught herein.

As used herein the term “biocontrol” or “biological control” refers to control of pests by interference with their ecological status, as by introducing a natural enemy or a pathogen into the environment. “Biocontrols” are interchangeably used with ‘biocontrol agents” and “biological control agents”, which are most often referred to as antagonists. Successful biological control reduces the population density of the target species. The term “biocontrol” as a biocontrol agent refers to a compound or composition which originates in a biological matter and is effective in the treatment, prevention, amelioration, inhibition, elimination or delaying the onset of at least one of bacterial, fungal, viral, insect, or any other plant pest infections or infestations and inhibition of spore germination and hyphae growth. It is appreciated that any biocontrol agent is environmentally safe, that it, it is detrimental to the target species, but does not substantially damage other species in a non-specific manner. Furthermore, it is understood that the term “biocontrol agent” or “biocontrol compound” also encompasses the term “biochemical control agent” or “biochemical control compound”.

As used herein the terms “biostimulant”, “biostimulants” or “biostimulant compound” refers to any microorganism or substance based on natural resources, in the form in which it is supplied to the user, applied to plants, seeds or the root environment soil and any other substrate with the intention to stimulate natural processes of plants to benefit their nutrient use efficiency and/or their tolerance to stress, regardless of its nutrients content, or any combination of such substances and/or microorganisms intended for this use. In some embodiments, biostimulants refer to biologically active compounds a polypeptide, a metabolite, a semiochemical, a hormone, a pheromone, a micronutrient and a nucleic acid such as RNA biomolecule including antisense nucleic acid, dsRNA, shRNA, siRNA, miRNA, ribozyme, and aptamer.

As used herein the terms “biopesticide” or “biopesticides” refers to a substance or mixture of substances intended for preventing, destroying or controlling any pest. Specifically, the term relates to substances or mixtures which are effective for treating, preventing, ameliorating, inhibiting, eliminating or delaying the onset of bacterial, fungal, viral, insect- or other pest-related infection or infestation, spore germination and hyphae growth. They are also used as substances applied to crops either before or after harvest to protect the commodity from deterioration during storage and transport. Biopesticides include several types of pest management intervention through predatory, parasitic, or chemical relationships. The term has been associated historically with biological control—and by implication—the manipulation of living organisms. In some embodiments, biopesticides refer to biologically active compounds a polypeptide, a metabolite, a semiochemical, a hormone, a pheromone, a macronutrient, a micronutrient and a nucleic acid such as RNA biomolecule including antisense nucleic acid, dsRNA, shRNA, siRNA, miRNA, ribozyme, and aptamer.

The term “plant pathogen” or “pathogen” refers to an organism (bacteria, virus, protist, algae or fungi) that infects plants or plant components. Examples include molds, fungi and rot that typically use spores to infect plants or plant components (e.g fruits, vegetables, grains, stems, roots). A “plant pathogen” also includes all genes necessary for the pathogenicity or pathogenic effects in the plant, or that by their suppression or elimination, such effects are reduced or eliminated.

The term “pest” is defined herein as encompassing vectors of plant, humans or livestock disease, unwanted species of bacteria, fungi, viruses, insects, nematodes mites, ticks or any organism causing harm during or otherwise interfering with the production, processing, storage, transport or marketing of food, agricultural commodities, wood and wood products or animal feedstuffs. Insect pests include, but are not limited to, insects selected from the orders Coleoptera, Diptera, Hymenoptera, Lepidoptera, Mallophaga, Homoptera, Hemiptera Orthroptera, Thysanoptera, Dermaptera, Isoptera, Anoplura, Siphonaptera, Trichoptera, etc., particularly Lepidoptera and Coleoptera. Those skilled in the art will recognize that not all compounds are equally effective against all pests. Compounds of the embodiments display activity against insect pests, which may include economically important agronomic, forest, greenhouse, nursery ornamentals, food and fiber, public and animal health, domestic and commercial structure, household and stored product pests.

The term “subject” can be any singular or plural subject, including, but not limited to plants, crops, vegetables, and herbs. Said subjects can be healthy subjects or any subjects suffering or going to suffer from an disease caused by a pest, pathogen, or parasite. In some embodiments, the subject is a plant. In other embodiments, the subject is a pest, pathogen, or parasite.

The term “plant” or “target plant” includes any plant sustainable to a pathogen. It further includes whole plants, plant organs, progeny of whole plants or plant organs, embryos, somatic embryos, embryo-like structures, protocorms, protocorm-like bodies (PLBs), and suspensions of plant cells. Plant organs comprise, e.g., shoot vegetative organs/structures (e.g., leaves, stems and tubers), roots, flowers and floral organs/structures (e.g., bracts, sepals, petals, stamens, carpels, anthers and ovules), seed (including embryo, endosperm, and seed coat) and fruit (the mature ovary), plant tissue (e.g., vascular tissue, ground tissue, and the like) and cells (e.g., guard cells, egg cells, trichomes and the like). The class of plants that can be used in the disclosure is generally as broad as the class of higher and lower plants amenable to the molecular biology and plant breeding techniques, specifically angiosperms (monocotyledonous (monocots) and dicotyledonous (dicots) plants including eudicots. It includes plants of a variety of ploidy levels, including aneuploid, polyploid, diploid, haploid and hemizygous.

Examples of additional plants species of interest include, but are not limited to, corn, wheat, rice, barley, oat, rye, sorghum, millet, sugar cane, strawberry, blueberry, raspberry, blackberry, apple, grape, pear, peach, melon, cucumber, pumpkin, squash, soybean, sugar beet, spinach, swiss chard, potato, eggplant, tomato, sunflower, safflower, gladiolus, cotton, canola, alfalfa, cannabis, Brassica, peanut, tobacco, banana, duckweed, pineapple, date, onion, cashew, pistachio, citrus, rose, almond, coffee, bean, legume, watermelon, squash, cabbage, turnip, mustard, cacti, pecan, flax, sweet potato, coconut, avocado, cantaloupe, vegetables, and herbs.

The term “cationic polymer” refers to any polymer that has a net positive charge, such as at a particular pH, including in this definition those cationic polymers on which changes have been made such as chemical or enzymatic fragmentation, derivatization or modification. Non-limiting examples of suitable cationic polymers are polysaccharides, proteins and synthetic polymers. Cationic polysaccharides include cationic cellulose derivatives, cationic guar gum derivatives, chitosan and derivatives thereof and cationic starches. Suitable cationic polysaccharides include cationically modified cellulose, particularly cationic hydroxyethylcellulose and cationic hydroxypropylcellulose. In one embodiment, the cationic polymer is or comprises chitosan. It will be apparent to the skilled person that chitosan is a (random) linear polymer of β-1,4-D- glucosamine and N- acetyl-D-glucosamine. Chitosan can be derived from chitin in the shells of crabs and other crustaceans as well as from fungi and insects.

The term “anionic polymer” refers to any polymer having a net negative charge, including in this definition those anionic polymers on which changes have been made such as chemical or enzymatic fragmentation, derivatization or modification. Exemplary anionic polymers include, but are not limited to, hyaluronic acid, polyaspartic acid, polyglutamic acid, polyacrylic acid, alginic acid, polystyrenesulfonate colominic acid, polysialic, chondroitin, keratan, dextrans, heparin, sulfonated lignin, carrageenan, furceleranos, alginates, agar, glucomannan, gellan gum, locust bean gum, guar gum, tragacanth gum, gum arabic, xanthan gum, karaya gum, pectins, celluloses, starches, sorbitan esters and salts or fragments thereof or derivatives thereof. In one embodiment, the anionic polymer is or comprises an alginate. In this regard, it will be understood that alginate is a linear copolymer of (1-4)-β-D-mannuronate and a-L-guluronic acid. In another embodiment, the anionic polymer is or comprises a dextran or a dextran sulfate.

Other polyions (i.e., anionic or cationic polymers) that can be utilized for performing the disclosure include, without limitation thereto, poly-L-lysine, carboxymethylcellulose, poly(sodium 4-styrenesulfonate), poly(allylamine hydrochloride), sodium polystyrene sulfonate, poly(styrene)-co-styrene sodium sulfonate (NaPSS), PLGA (polylactic-co-gly colic acid) and polyacrylic acid.

The term “coating platform” refers to a structure, matrix, or scaffold of a layer-by-layer assembly composed of biopolymers including naturally occurring biopolymers and degradable synthetic biopolymers taught herein. Platforms can be interchangeably used with matrices, structures, or scaffolds herein.

### Biopolymer Layer

The polymer or polymers can be naturally occurring or synthetic. In some embodiments, the polymer or polymers are naturally occurring. In some embodiments, the polymer or polymers are synthetic. In some embodiments, the polymer or polymers are biodegradable. In this disclosure, the polymer or polymers used in the platforms, compositions, and formulations provided herein are biopolymer.

The term “biopolymer” refers to natural polymers produced by the cells of living organisms as well as biodegradable synthetic polymers. Biopolymers consist of monomeric units that are covalently bonded to form larger molecules. There are three main classes of biopolymers, classified according to the monomers used and the structure of the biopolymer formed: polynucleotides, polypeptides, and polysaccharides. Polynucleotides, such as RNA and DNA, are long polymers composed of 13 or more nucleotide monomers. Polypeptides and proteins are polymers of amino acids, and some major examples include collagen, actin, and fibrin. Polysaccharides are linear or branched polymeric carbohydrates and examples include starch, cellulose, and alginate. Other examples of biopolymers include natural rubbers (polymers of isoprene), suberin and lignin (complex polyphenolic polymers), cutin and cutan (complex polymers of long-chain fatty acids) and melanin. Biopolymers have various applications such as in the agricultural and food industry, manufacturing, packaging, and agricultural engineering. In some embodiments, biodegradable synthetic polymer is a biopolymer of the present disclosure.

The term “polymer multilayer” or “multilayered polymer” refers to the composition formed by sequential and repeated application of polymer(s) to form a multilayered structure. For example, polyelectrolyte multilayers are polymer multilayers are formed by the alternating addition of anionic and cationic polyelectrolytes for delivery of an agricultural agent. In some embodiments, the term “polymer multilayer” also refers to the composition formed by sequential and repeated application of polymer(s) to an agricultural agent or for encapsulation and delivery of an agricultural agent. In addition, the term “polymer layer” can refer to a single layer composed of polymer molecules, such as anionic or cationic polyelectrolyte molecules, existing either as one layer within multiple layers, or as a single layer of only one type of polyelectrolyte molecules on an agricultural agent or for encapsulation and delivery of an agricultural agent. While the delivery of the agricultural agent coated by the polymers to a subject is sequential in preferred embodiments, the use of the term “polymer multilayer” is not limiting in terms of the resulting structure of the coating. It is well understood by those skilled in the art that inter-diffusion of polymers such as polyelectrolytes can take place leading to structures that may be well-mixed in terms of the distribution of anionic and cationic polyelectrolytes. It is also understood that the term polyelectrolyte includes polymer species as well as nanoparticulate species, and that it is not limiting in scope other than to indicate that the species possesses multiple charged or partially charged groups. It is also well understood by those skilled in the art that multilayer structures can be formed through a variety of non-covalent interactions including electrostatic interactions and others such as hydrogen bonding.

The term “polyelectrolyte” refers to a water-soluble macromolecular polymer substance containing many repeating ionic constituent units, including cations and anions.

In some embodiments, the polymers provide at least one layer for adsorbing, coating, or encapsulating at least one agricultural agent taught herein. In some embodiments, the polymers provide a matrix for adsorbing, coating, or encapsulating at least one agricultural agent taught herein. In some embodiments, the polymers provide a polymer multilayer for adsorbing, coating, or encapsulating at least one agricultural agent taught herein. In some embodiments, the polymer of the composition can be a homopolymer or a heteropolymer.

In some embodiments, the polymer is a naturally occurring polymer, e.g., derived from whey protein isolate (WPI), soy protein isolate, corn proteins, rice proteins, wheat proteins, milk proteins, wheat gluten, pectin, collagen, gelatin, zein, mucins, sucrose esters, lipids, gums, alginates, chitosan, cellulose, cellulose-based polymers, starch, and/or starch-based polymers. In some embodiments, the polymer is a food protein polymer, e.g., a polymer derived from milk protein (e.g., whey, casein), soy protein, corn protein (e.g., zein), rice protein and/or wheat protein. In some embodiments, the polymer is derived from plant proteins, e.g., soy protein, corn protein (e.g., zein), rice protein or wheat protein. In some embodiments, the polymer is a synthetic polymer, including, but not limited to, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), biodegradable copolymers (e.g., AB diblock and ABA triblock polymers such as Poly(ethylene glycol) methyl ether-block-poly(D,L lactide), PEG-PLA; PLA-PEG-PLA, PLGA-PEG-PLGA, and mixtures thereof.

In some embodiments, the polymer is selected from the group consisting of whey protein isolate (WPI), soy protein isolate, corn proteins, mucins, rice proteins, wheat proteins, milk proteins, wheat gluten, pectin, collagen, gelatin, zein, sucrose esters, lipids, gums, alginates, chitosan, cellulose, cellulose-based polymers, starch, starch-based polymers, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), biodegradable copolymers (e.g., AB diblock and ABA triblock polymers such as Poly(ethylene glycol) methyl ether-block-poly(D,L lactide), PEG-PLA; PLA-PEG-PLA, PLGA-PEG-PLGA, and mixtures thereof.

The term “crosslinked” herein refers to a composition containing intermolecular crosslinks and optionally intramolecular crosslinks as well, arising from the formation of covalent bonds. Covalent bonding between two crosslinkable components may be direct, in which case an atom in one component is directly bound to an atom in the other component, or it may be indirect, through a linking group.

A crosslinked structure may, in addition to covalent bonds, also include intermolecular and/or intramolecular noncovalent bonds such as hydrogen bonds and electrostatic (ionic) bonds. Non-covalent interactions can be classified into electrostatic, π-effects, van der Waals forces, and hydrophobic effects. Non-covalent interactions are critical in maintaining the three-dimensional structure of large molecules, such as proteins and nucleic acids. In addition, they are also involved in many biological processes in which large molecules bind specifically but transiently to one another. In some embodiments, the non-covalent interactions also affect design of materials, particularly for self-assembly taught herein. Also, intermolecular forces are non-covalent interactions that occur between different molecules, rather than between different atoms of the same molecule.

In some embodiments, the polymer or polymers can be crosslinked. In some embodiments, the crosslinks are noncovalent bonds that involve more dispersed variations of electromagnetic interactions between molecules or within a molecule.

In some embodiments, the crosslinks are covalent bonds (e.g., disulfide bonds). For example, protein-based or protein-derived polymers may utilize disulfide bonds for crosslinking and polysaccharide-based or polysaccharide-derived polymers may utilize hydrogen bonds for crosslinking.

The crosslinks can also be introduced by chemical crosslinking. In some embodiments, the chemical cross-linking materials may include small ions such as chemicals or small molecular weight chemical cross linkers such as glutaraldehyde or enzymatic cross linkers such as transglutaminase. Higher levels of crosslinking typically reduce the solubility of polymeric materials and increase the polymer resistance against various solvents including water. Crosslinked and non-crosslinked polymer can be combined to adjust for the level of porosity of the polymer matrix and the level of release of the agricultural agents upon contact of the compositions with an external stimulus (e.g., an aqueous solution, moisture, light,). Relatively lower levels of crosslinking allow for higher levels of agricultural agent release. Conversely, higher levels of crosslinking allow for lower levels of agricultural release. The level of crosslinked polymer in the compositions can be controlled using any method known in the art. For example, the length of time a crosslinking reaction is allowed to proceed can be lengthened for increased crosslinking or shortened for reduced crosslinking. Levels of crosslinking can also be controlled by combining different levels of crosslinked and non-crosslinked polymer in the compositions.

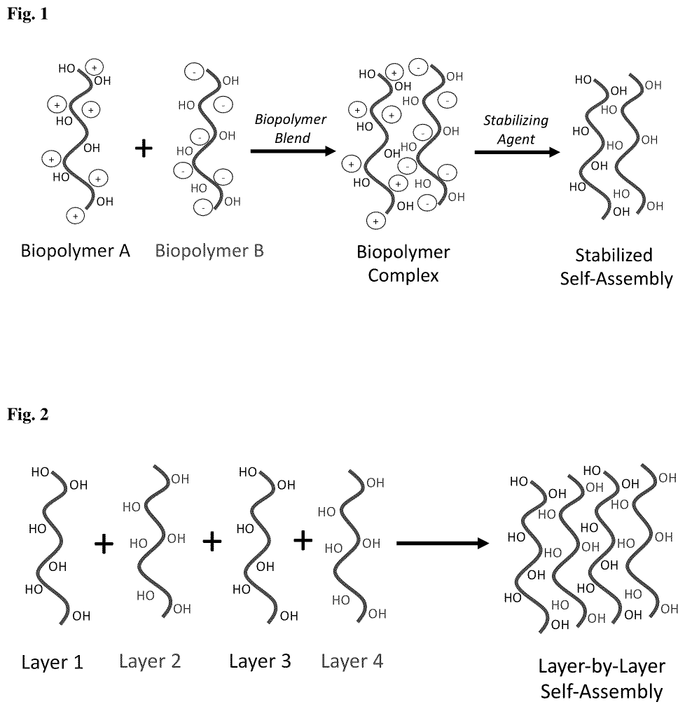

In some embodiments, the polymer multilayer, the layer-by-layer self-assembly complex can be followed by stabilization of the finished self-assembled macromolecular arrangement upon addition of stabilizing agent as illustrated in FIG. 1. In some embodiments, the stabilizing agent can reduce reversible non-covalent interactions, depicting in a stabilized irreversible macrostructure supported by high density intermolecular hydrogen bonding. The stabilizing agent can be selected from a group composed by pH regulators, non-ionic surfactants or crosslinker agents. Table 1 summarizes examples of suitable stabilizing agents for the layer-by-layer self-assembly complex.

TABLE 1
Selected examples of stabilizing agents
for non-covalent biopolymer complexes.

| Stabilizing Agent Group | Selected Examples |
|---|---|
| pH Regulators | Phosphate buffer saline (PBS), ammonium |
| | buffer, acetate buffer, citrate buffer, carbonate |
| | buffer |
| Non-ionic surfactants | Poloxamer, polysorbate, stearyl alcohol, PEG-10 |
| | sunflower glycerides, nonoxynol, lauryl |
| | glucoside, maltosides, cetyl alcohol, cocamide |
| | DEA, decyl glucoside, glycerol monostearate, |
| | alkyl polyglycoside, mycosubtilin, tween |
| Crosslinkers | Genipin, calcium chloride, tripolyphosphate, |
| | proanthocyanidins, epigallocatechin gallate, |
| | glucosaminoglycans |

In some embodiments, a composition comprising an agricultural agent coated by a polymer comprises from about 0.01% w/v to about 50% w/v polymer, from about 0.05% w/v to about 40% w/v polymer, from about 0.1% w/v to about 30% w/v polymer, from about 0.1% w/v to about 20% w/v polymer or from about 0.1% w/v to about 10% w/v polymer.

Provided herein is a coating platform for agricultural use, comprising a layer-by-layer assembly. In some embodiments, the layer-by-layer assembly comprises at least two biopolymers. In some embodiments, said two biopolymers are selected from chitosan, alginate, dextran sulfate, collagen, fibrinogen, gelatin, heparin, sulfonated lignin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, and combinations thereof.

In some embodiments, a first biopolymer is chitosan. In some embodiments, a second biopolymer is alginate or dextran sulfate.

In other embodiments, said at least two biopolymers comprise chitosan and alginate. In other embodiments, said at least two biopolymers comprise chitosan and dextran sulfate.

In some embodiments, said two biopolymers are assembled by a noncovalent bond.

In some embodiments, one selected biopolymer can form said layer-by-layer assembly comprising the selected biopolymer by said noncovalent bond.

In some embodiments, said platform covers, protects, coats, or encapsulates an agricultural agent. In embodiments, said platform comprises an agricultural agent within the platform

In some embodiments, said platform is stabilized by an addition of a stabilizing agent. Said stabilizing agent is selected from a pH regulator, a non-ionic surfactant and a crosslinker agent as listed in Table 1.

In some embodiments, said agricultural agent is a biologically active agent, or an agricultural product.

The compositions generally contain polymer concentrations to have a viscosity sufficient to form a film, a nanoparticle, a molecular aggregate, or a microcapsule on a desired surface but not too viscous to impede depositing material or forming a film on a surface.

In some embodiments, the polymer coating platform can form stand-alone films. In some embodiments, the polymer coating platform can also be deposited as an emulsion (e.g., a water-in-oil emulsion or a water-in-oil-in-water emulsion), a dip coating, a spray coating, a dissolution, or a combination thereof. In those applications, it is desired that these polymers form a continuous barrier coating on the surface (e.g., agricultural agents as well as agricultural products including food materials such as herbs, fresh vegetables, leafy vegetables, cut vegetables, and fresh fruits). For forming an effective dip coating, it is desired that the surface contact properties (contact angle and affinity for bonding with surface of agricultural agents and products) is favorable. The favorable properties can be determined by non-covalent bonding such as hydrogen bonding. In some embodiments, carbohydrate-based or polysaccharide-based polymers as an emulsion can be deposited on the fresh produce surfaces by a dip coating.

The polymer or polymers included in the composition are selected appropriate for the desired context, for example, depending on the release mechanism or the coating method. In some embodiments, the polymers used for emulsions, film-based, dip-coating, spray-coating, dissolution, and combinations thereof, include without limitation polysaccharide-based polymers such as chitosan, sugar-based dextran; cellulose-based polymers such as HPMC and alginates; and lipids (including oils and waxes) and/or proteins such as whey protein isolate.

Furthermore, the release of agricultural agents from the compositions can be adjusted by controlling the hydrophilicity of the composition. For example, polymers can be selected based on their extent of wetting properties to control the release.

In some embodiments, polymers with wetting properties of polysaccharide-based polymers are useful for more controlled/delayed release of agricultural agents from the compositions. In other embodiments, polymers with wetting properties of protein and sugar-based polymers are useful for rapid release of agricultural agents from the compositions.

It is known that a versatile method of self assembled architectures based on the alternate deposition of polyanions and polycations has been developed for the buildup of multilayered polyelectrolyte films (Decher, 1997, Science 277:1232). Besides film thickness, roughness, and porosity, it is also possible to incorporate in the film architecture functionalized macromolecules (Caruso et al., 1997, Langmuir 13:3427; Cassier et al., 1998, Supramol. Sci. 5:309). It has also been demonstrated that the layer-by-layer deposition process is not limited in applicability to polyelectrolytes, but can be applied to nanoparticles, non-ionic polymers, proteins and other forms of microscopic and nanoscopic matter. In some embodiments, a wide range of species and interfacial structures can be formed by the layer-by-layer deposition procedure. The scope of the disclosure described herein applies to all species that have been demonstrated to be incorporated into interfacial structures, which are known in the art, by the layer-by-layer deposition process, such as Rawtani and Agrawal, 2014, Nanobiomedicine, 1, 8).

### 1. Natural Biopolymers

The present disclosure teaches natural biopolymers as primary bioactive substances used in the applications of medical materials. Based on their monomeric units and structure, biopolymers are categorized roughly into three classes:
(i) Polypeptide- and protein-based: collagen, fibrin, fibrinogen, gelatin, silk, elastin, myosin, keratin, and actin.
(ii) Polysaccharide-based: chitin, chitosan, alginate, hyaluronic acid, cellulose, agarose, dextran, and glycosaminoglycans.
(iii) Polynucleotide-based: DNA, linear plasmid DNA, and RNA.

Natural biopolymers consist of long chains, including nucleotides, amino acids, or monosaccharides made of repeating covalently bonded groups. Biofunctional molecules which ensure bioactivity, biomimetic nature, and natural restructuring are typically found in such polymers. Bioactivity, biocompatibility, 3D geometry, antigenicity, non-toxic byproducts of biodegradation, and intrinsic structural resemblance are the most important properties of natural polymers (Ogueri et al, 2019). Natural polymers can be used in the manufacture of matrix or scaffolds for agricultural agent delivery. In some embodiments, naturally derived polymers including collagen, chitin, chitosan, gelatin, silk fibroin, soybean, fibrinogen (Fbg), fibrin (Fbn), elastin, proteoglycan, hyaluronan, and laminin have potential in the agricultural applications.

Once group of naturally occurring polymers is polysaccharides made of different units of monosaccharide or disaccharide chains (e.g., starch, cellulose, etc.). Chitin and chitosan are interesting materials for agricultural applications because they have positive properties that make them ideal in the agricultural field, such as non-toxicity, biodegradability, and biocompatibility. These materials often reflect a wide range of proprieties owing to their reactive hydroxy and amino groups, high charge density, as well as their broad hydrogen-bonding capacities and the single chemical structure. The combination of diverse physicochemical and biological features allows a vast variety of agricultural uses. Chitin is generally found in shells of crustaceans and its derivative chitosan is obtained by deacetylation of chitin. Owing to the excess of their reactive amino and hydroxy groups and cations, chitin and chitosan are coupled with other molecules to boost the biological functions of other materials. For instance, it is established that the hydrophilicity of other biomaterials and their biocompatibility are improved by chitosan coating. The present disclosure teaches one of the naturally occurring polymers, chitosan, for agricultural applications.

There are major advantages to natural biopolymers over synthetic materials, including lower/no toxicity, better bioactivity, enhanced cell response when associated with cells, excellent biocompatibility, extreme hydrophilicity, and effective biological function.

### 2. Synthetic Biopolymers

Synthetic biopolymers are advantageous in a few characteristics such as tunable properties, endless forms, and established structures over natural polymers. Polymerization, interlinkage, and functionality (changed by block structures, by combining them, by copolymerization) of their molecular weight, molecular structure, physical and chemical features make them easily synthesized as compared to naturally occurring polymers. Many commercially available synthetic polymers exhibit similar physicochemical and mechanical characteristics to biological tissues. In biodegradable polymers, synthetic polymers are a major category and can be produced under controlled conditions. In a broad spectrum, the mechanical and physical characteristics are predictable and reproducible, such as strength, Young's modulus, and degradation rate (Reddy et al, 2021).

Poly(-hydroxy esters) including PCL, PGA, PLA, and their copolymer PLGA and poly(ethers) including PEO and PEG, PVA, and PU are the most widely studied degradable synthetic materials.

Comprehensive analysis of naturally occurring and synthetic biopolymers along with their structures, properties and use is disclosed in Reddy et al, 2021, which is incorporated by reference.

The present disclosure teaches a coating platform for agricultural use, comprising a layer-by-layer assembly of at least two biopolymers.

In some embodiments, said at least two biopolymers comprise chitosan and alginate. Chitosan and alginate are naturally occurring polysaccharides extracted from crustacean shells and brown algae, respectively, and used for forming the multilayered biopolymer platform, structure, matrix, or scaffold because of their biodegradability, biocompatibility and film-forming ability. Chitosan has antimicrobial activity against a wide range of bacteria in acidic media (Fernandez-Saiz, Lagaron, & Ocio, 2009). ALG can be oxidized by sodium periodate to generate alginate dialdehyde (ADA). The active aldehyde groups of ADA can react with the amino groups present in Chitosan to form Schiff bases (—RC═N—) (Aston et a. 2015; Wang et al., 2019). The multilayered biopolymer of chitosan and alginate can have an enhanced antimicrobial activity.

Polymer mixes describe a polymer material consisting of at least two or more polymers resulting in improved physicochemical properties compared to different individual polymers.

In some embodiments, natural-natural biopolymer composites are formed and present.

In some embodiments, natural-synthetic biopolymer composites are formed and present.

### Polymer Multilayer Assembly and Materials

The present disclosure provides coating platforms, compositions, formulations, methods for preparing a multilayer structure on an agricultural agents and products. In some embodiments, the multilayer structures comprise layers of polymers that form polyelectrolytes, while in other embodiments, the multilayers comprise polymers that do not have a charge (i.e., non-ionic polymers) or a combination of charged and uncharged polymer layers.

In some embodiments, polymer multilayers built-up by the alternated adsorption of cationic and anionic polyelectrolyte layers constitute a coating platform to encapsulate and deliver agricultural agents and products in a controlled way. One of the most important properties of such multilayers is that they exhibit an excess of alternatively positive and negative charges (Caruso et al., 1999, J Am Chem Soc 121:6039; Ladam et al., 2000, Langmuir 16:1249). Not only can this constitute the motor of their buildup (Joanny, 1999, Eur. Phys. J. Biol. 9:117), but it allows, by simple contact, to adsorb a great variety of compounds such as dyes, particles (Cassagneau et al., 1998, J. Am. Chem. Soc. 120:7848; Caruso et al., 1999, Langmuir 15:8276; Lvov et al., 1997, Langmuir 13:6195), clay microplates (Ariga et al., 1999, Appl. Clay Sci. 15:137) and proteins (Keller et al., 1994, J. Am. Chem. Soc. 116:8817; Lvov et al., 1995, J. Am. Chem. Soc. 117:6117; Caruso et al., 1997, Langmuir 13:3427).

In some embodiments, the polymer multilayers, such as polyelectrolyte multilayers, are nanoscale in dimension. In some embodiments, the polymer multilayers are from about 1 nm to 1000 nm thick, from about 1 nm to 500 nm thick, from about 1 nm to 300 nm thick, from about 1 nm to about 200 nm thick, from about 1 nm to about 100 nm thick. In some embodiments, the polymer multilayers are less than about 500 nm, 300 nm, 200 nm 100 nm or 50 nm thick. The nanoscale dimension of the polymer multilayers (i.e., the nanoscale thickness) allows for the loading of a lower total amount of an agricultural agent while still allowing delivery of an effective amount (i.e., an amount of an agricultural agent as compared to controls) of the agricultural agent as compared to matrix structures with greater thickness.

Polyelectrolytes are polymers with ionizable repeating groups, such as polyanions and polycations. These groups can dissociate in polar solvents such as water, leaving charges on polymer chains and releasing counterions into the solution (Bhattarai et al., 2010; Schatz et al., 2004; Wu and Delair, 2015). Polyelectrolyte complexes (PECs) offer the possibility of combining physicochemical properties of at least two polyelectrolytes (Schatz et al., 2004). The PECs are formed by strong electrostatic interactions between oppositely charged polyelectrolytes, leading to interpolymer ionic condensation and the simultaneous release of counterions (Wu and Delair, 2015; Luo and Wang, 2014). Other interactions between two ionic groups to form PEC structures include hydrogen bonding, hydrophobic interactions, van der Waals' forces, or dipole-dipole charge transfer.

The cationic polyelectrolyte poly(L-lysine) (PLL) interacts with anionic sites on cell surfaces and in the extracellular matrix (Elbert and Hubbell, 1998, J. Biomed. Mater. Res. 42:55). In some embodiments, the present disclosure provides a method of producing a polymer-coated agricultural agent with the sequential application of an agricultural agent, a cationic polyelectrolyte, and an anionic polyelectrolyte. In other embodiments, the application includes the sequential and repeated application of a cationic polyelectrolyte, an anionic polyelectrolyte, and an agricultural agent for production and delivery of the polymer-coated agricultural agents.

Polyelectrolyte layers are formed by alternating applications of anionic polyelectrolytes and cationic polyelectrolytes to surfaces to form a polyelectrolyte layer. The layers can be used to deliver an agricultural agent to a subject. At least two layers are used to form the polyelectrolyte multilayer. In some embodiments, more than two layers are used. In other embodiments, 3, 4, 5, 6, 7, 8, 9, 10, 15, 20, 25, 30, 35, 40, 45, 50 or more layers are used. In some embodiments, a polymer multilayer comprises at least two layers comprising one bilayer of the two components, which may be effective for promoting controlled release. In some embodiments, a polymer multilayer comprises at least four layers comprising two bilayers of the two components, which may be effective for promoting controlled release.

The method of the present disclosure is not limited to use on an agricultural agent. The formation of a polyelectrolyte layer may be formed on any surface to which delivery of an agricultural agent is desirable.

In some embodiments, the use of a variety of polyelectrolytes is contemplated, including, but not limited to, poly(ethylene imine) (PEI), poly(allylamine hydrochloride) (PAH), poly(sodium 4-styrenesulfonate) (PSS), poly(acrylic acid) (PAC), poly(maleic acid-co-propylene) (PMA-P), poly(acrylic acid) (PAA), and poly(vinyl sulfate) (PVS). It is also possible to use naturally occurring polyelectrolytes, including hyaluronic acid and chondroitin sulfate.

### 1. Cationic Polymers

Cationic polymers useful in the present disclosure can be any biocompatible water-soluble polycationic polymer, for example, any polymer having protonated heterocycles attached as pendant groups. As used herein, “water soluble” means that the entire polymer must be soluble in aqueous solutions, such as buffered saline or buffered saline with small amounts of added organic solvents as co-solvents, at a temperature between 20 and 37° C. In some embodiments, the material will not be sufficiently soluble (defined herein as soluble to the extent of at least one gram per liter) in aqueous solutions per se but can be brought into solution by grafting the polycationic polymer with water-soluble polynonionic materials such as polyethylene glycol.

Representative cationic polymers include natural and unnatural polyamino acids having net positive charge at neutral pH, positively charged polysaccharides, and positively charged synthetic polymers. Examples of suitable polycationic materials include polyamines having amine groups on either the polymer backbone or the polymer side chains, such as poly-L-lysine (PLL) and other positively charged polyamino acids of natural or synthetic amino acids or mixtures of amino acids, including, but not limited to, poly(D-lysine), poly(ornithine), poly(arginine), and poly(histidine), and nonpeptide polyamines such as poly(aminostyrene), poly(aminoacrylate), poly (N-methyl aminoacrylate), poly (N-ethylaminoacrylate), poly(N,N-dimethyl aminoacrylate), poly(N,N-diethylaminoacrylate), poly(aminomethacrylate), poly(N-methyl amino-methacrylate), poly(N-ethyl aminomethacrylate), poly(N,N-dimethyl aminomethacrylate), poly(N,N-diethyl aminomethacrylate), poly(ethyleneimine), polymers of quaternary amines, such as poly(N,N,N-trimethylaminoacrylate chloride), poly(methyacrylamidopropyltrimethyl ammonium chloride), and natural or synthetic polysaccharides such as chitosan. In some embodiments, PLL is a preferred material. In some preferred embodiments, the cationic polymer is poly(allylamine hydrochoride) (PAH).

In general, the polymers must include at least two charges, and the molecular weight of the polycationic material must be sufficient to yield the desired degree of binding to an agent or other surface.

Chitosan has cationic nature due to the protonation of amino groups on the polymer backbone and becomes a cationic polyelectrolyte upon dissolution in aqueous acetic acid (Luo and Wang, 2014). Mixing cationic chitosan polyelectrolyte with negatively charged polyelectrolyte molecules forms spontaneous, entropy-driven PECs, which can be water-soluble or precipitated. Nonstoichiometric ratios of two polyelectrolytes lead to particle formation. The size of PECs is influenced by the polyelectrolyte concentration, charge density, mixing ratio, and pH. The charge density of the chitosan polyelectrolyte depends on the pH of the solution and degree of deacetylation (DDA) of chitosan. With increasing DDA (DDA>50%), positive charge density of the chitosan polymer increases and hence exhibits a large number of cross-linking sites to make PECs (Fan et al., 2012, Delair, 2011). The particle size of chitosan PECs decreases with decreases in DDA of chitosan and its molar mass (Schatz, 2004).

Several different types of polyanions have been used to form chitosan PECs, including natural polymers such as hyaluronic acid, alginate, dextran sulfate, carrageenan, chondroitin sulfate, pectin, xanthan gum, cellulose, collagen, sulfonated lignin, and heparin. Synthetic polymers such as poly(acrylic acid) and protein-based molecules such as insulin, DNA, and RNA also form complexes with chitosan, often referred to as polyplexes (Bhattarai et al., 2010; Schatz et al., 2004; Luo and Wang, 2014). The formation of chitosan PEC particles is highly dependent on the characteristics of both electrolytes, such as charge density, chain length (molecular weight), ionic strength, and concentration of polymer solution.

In some embodiments, chitosan-based coating platform for agricultural applications is that the preparation method does not use any toxic organic chemical cross-linkers, catalysts, or volatile organic solvents and avoids the use of high temperatures.

### 2. Anionic Polymers

Polyanionic materials useful in the present disclosure can be any biocompatible water-soluble polyanionic polymer, for example, any polymer having carboxylic acid groups attached as pendant groups. Suitable materials include alginate, carrageenan, furcellaran, pectin, xanthan, hyaluronic acid, heparin, heparan sulfate, chondroitin sulfate, dermatan sulfate, dextran sulfate, sulfonated lignin, poly(meth)acrylic acid, oxidized cellulose, carboxymethyl cellulose and crosmarmelose, synthetic polymers and copolymers containing pendant carboxyl groups, such as those containing maleic acid or fumaric acid in the backbone. Polyaminoacids of predominantly negative charge are also suitable. Examples of these materials include polyaspartic acid, polyglutamic acid, and copolymers thereof with other natural and unnatural amino acids. Polyphenolic materials such as tannins and lignins can be used if they are sufficiently biocompatible. In some embodiments, anionic polymer materials include alginate, pectin, carboxymethyl cellulose, heparin and hyaluronic acid. In some embodiments, the anionic polymer is alginate or dextran sulfate. In other embodiments, the anionic polymer is sulfonated lignin.

### 3. Nonionic Polymers

In some embodiments, the multilayer structures are formed from uncharged polymers or from a combination of charged and uncharged polymers. Examples of uncharged polymers include, but are not limited to, dextran, dextran sulfate, diethylaminoethyl (DEAE)-dextran, hydroxyethyl cellulose, ethyl(hydroxyethyl) cellulose, acrylamide, polyethylene oxide, polypropylene oxide, polyethylene oxide-polypropylene oxide copolymers, PAANa, Ficoll, polyvinylpyrolidine, and polyacrylic acid.

### 4. Amphoteric Polymers

In some embodiments, the multilayer structures are formed from one or more amphoteric polymers, alone in combination with the other polymers described herein. In some embodiments, the amphoteric polymers comprise one or more of acrylic acid (AA), DMAEMA (dimethylaminoethyl methacrylate), APA (2-aminopropyl acrylate), MorphEMA (morpholinoethyl methacrylate), DEAEMA (diethylaminoethyl methacrylate), t-ButylAEMA (t-butylaminoethyl methacrylate), PipEMA (piperidinoethyl methacrylate), AEMA (aminoethyl methacrylate), HEMA (2-hydroxyethyl methacrylate), MA (methyl acrylate), MAA (methacrylic acid) APMA (2-aminopropyl methacrylate), AEA (aminoethyl acrylate). In some embodiments, the amphoteric polymer comprises (a) carboxylic acid, (b) primary amine, and (c) secondary and/or tertiary amine. The amphoteric polymers have an isoelectric point of 4 to 8, and have a number average molecular weight in the range of 10,000 to 150,000.

The present disclosure teaches a layer or coating comprising a polymer that comprises multiple electrolytic repeat units that dissociate in solutions, making the polymer charged. The layer or coating of the present disclosure comprises a polyelectrolyte complex, that is, an intermolecular blend of a predominantly positively-charged polyelectrolyte and a predominantly negatively-charged polyelectrolyte. The polyelectrolyte complex is in the form of a thin film achieved by multilayering.

In some embodiments, a polyelectrolyte complex is formed by combining a predominantly negatively charged polyelectrolyte and a predominantly positively charged polyelectrolyte. In other embodiments, the polyelectrolyte complex uses alternating exposure of a substrate to solutions each containing one of the polyelectrolytes; in this embodiment, at least one solution comprises at least one predominantly positively-charged polyelectrolyte, and at least one solution comprises at least one predominantly negatively-charged polyelectrolyte.

The charged polymers (i.e., polyelectrolytes) used to form the polyelectrolyte complex thin film are water soluble and/or organic soluble and comprise one or more monomer repeat units that are positively or negatively charged. The polyelectrolytes used in the present disclosure may be copolymers that have a combination of charged and/or neutral monomers (e.g., positive and neutral; negative and neutral; positive and negative; or positive, negative, and neutral). Regardless of the exact combination of charged and neutral monomers, a polyelectrolyte of the present disclosure is predominantly positively charged or predominantly negatively charged.

Further examples of polyelectrolytes include charged biomacromolecules, which are naturally occurring polyelectrolytes, or synthetically modified charged derivatives of naturally occurring biomacromolecules, such as modified celluloses, chitosan, or guar gum. A positively-charged biomacromolecule usually comprises a protonated sub-unit (e.g., protonated amines). Some negatively charged biomacromolecules comprise a deprotonated subunit (e.g., deprotonated carboxylates or phosphates). Examples of biomacromolecules which may be charged for use in accordance with the present disclosure include proteins, polypeptides, enzymes, DNA, RNA, glycosaminoglycans, alginate, alginic acid, chitosan, chitosan sulfate, cellulose sulfate, polysaccharides, dextran sulfate, carrageenin, hyaluronic acid, sulfonated lignin, and carboxymethylcellulose.

The present disclosure teaches advantages of the naturally occurring polyelectrolytes are that they may be inexpensive, widely available, and nontoxic. Other properties of the naturally occurring polyelectrolytes are that their complexes can be soft and hydrated and they may be degraded or consumed by natural organisms. In some embodiments, the naturally occurring biopolymers (i.e. polyelectrolytes) are biodegradable and bioactive.

Chitosan has cationic nature due to the protonation of amino groups on the polymer backbone and becomes a cationic polyelectrolyte upon dissolution in aqueous acetic acid (Luo and Wang, 2014). Mixing cationic chitosan polyelectrolyte with negatively charged polyelectrolyte molecules forms spontaneous, entropy-driven PECs, which can be water-soluble or precipitated. Nonstoichiometric ratios of two polyelectrolytes lead to particle formation. For chitosan PEC particle formation, many investigators have used cation polyelectrolyte solution (chitosan) in excess of anionic polyelectrolytes (Schatz et al., 2004). The size of PECs is influenced by the polyelectrolyte concentration, charge density, mixing ratio, and pH. The charge density of the chitosan polyelectrolyte depends on the pH of the solution and degree of deacetylation (DDA) of chitosan. With increasing DDA (DDA>50%), positive charge density of the chitosan polymer increases and hence exhibits a large number of cross-linking sites to make PECs (Fan et al., 2012, Delair, 2011). The particle size of chitosan PECs decreases with decreases in DDA of chitosan and its molar mass (Schatz, 2004). Higher concentrations of low-molecular weight chitosan are required to form PECs with sufficient gel rigidity. High-molecular weight chitosan can form more robust PECs with highly cross-linked networks.

### Coating Platform for Agricultural Use

The present disclosure teaches a biodegradable, bioactive and controlled release promoting technology based on a composite coating platform formulated by alternating layers of biopolymers self-assembled by non-covalent interactions. The coating platform provides encapsulation and controlled release properties, and improved environmental stability of agricultural agents and products, based on polymers (e.g. naturally occurring polymers). The biopolymer coating platform depicts suitable biodegradation profiles in the field.

In some embodiments, the coating platform for agricultural use utilizes naturally occurring biopolymers, such as alginate, dextran, chitosan, hyaluronic acid, collagen and gelatin, among others, to fabricate alternated nanocoatings via layer-by-layer self-assembly technology. The platform is assembled based on non-covalent intermolecular interactions involving counter ion attraction and stabilization by high density hydrogen bonding as described in FIG. 1, allowing the formation of different macromolecular structures such as thin films, nanoparticles, molecular aggregates and microcapsules.

Non-covalent interactions are critical in maintaining the three-dimensional structure of large molecules, such as proteins and nucleic acids. In addition, they are also involved in many biological processes in which large molecules bind specifically but transiently to one another. These interactions also heavily influence drug design, crystallinity and design of materials, particularly for self-assembly, and, in general, the synthesis of many organic molecules. A non-covalent interaction differs from a covalent bond in that it does not involve the sharing of electrons, but rather involves more dispersed variations of electromagnetic interactions between molecules or within a molecule. Non-covalent interactions can be classified into different categories, such as electrostatic, hydrogen bonding, π-effects, van der Waals forces, and hydrophobic effects.

The coating platform taught herein allows tailoring non-covalent interactions between naturally occurring biopolymers, facilitating the manufacturing of a wide range of macromolecular arrangements, through a layer-by-layer self-assembly approach (FIG. 2), useful for different agricultural applications.

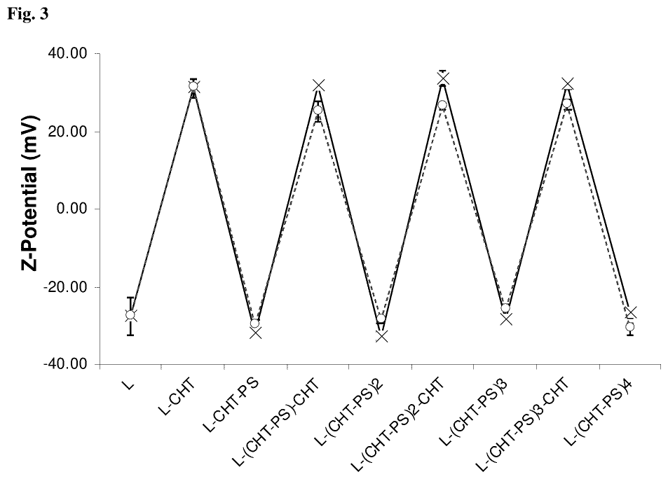

The efficacy of the proposed mechanisms for fabrication of the coating platform has been confirmed by different analysis involving zeta-potential and surface tension, as shown in FIG. 3. FIG. 3 shows the variation in zeta-potential upon addition of each new alternating biopolymer layer, confirming the formation of the biopolymer complex stationary stage suggested in FIG. 1, that will be followed by stabilization of the finished self-assembled macromolecular arrangement upon addition of stabilizing agent. In some embodiments, the stabilizing agent reduces reversible non-covalent interactions, depicting in a stabilized irreversible macrostructure supported by high density intermolecular hydrogen bonding. The stabilizing agent can be selected from a group composed by pH regulators, non-ionic surfactants or crosslinker agents, as presented in Table 1.

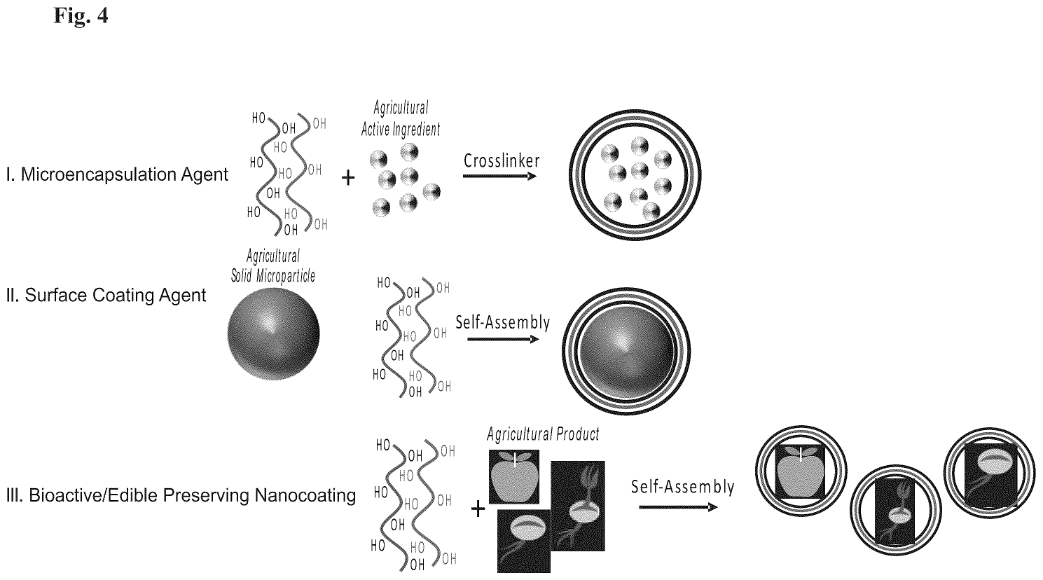

The present disclosure provides that the coating platform can be modulated via layer-by-layer self-assembly mechanism to manufacture different macromolecular arrangements that can be optimized for a wide spectrum of agricultural applications, ranging from controlled release formulations to edible coatings for preventing plant diseases. FIG. 4 illustrates featured agricultural applications for the coating platform.

In some embodiments, a coating platform for agricultural use, comprising a layer-by-layer assembly, wherein the layer-by-layer assembly comprises at least two biopolymers. In some embodiments, the two biopolymers are selected from chitosan, alginate, dextran sulfate, collagen, fibrinogen, gelatin, heparin, sulfonated lignin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, and combinations thereof. In some embodiments, the two biopolymers are assembled by a noncovalent bond. In some embodiments, one selected biopolymer can form said layer-by-layer assembly comprising the selected biopolymer by said noncovalent bond. In other embodiments, the platform coats or encapsulates an agricultural agent taught herein. In further embodiments, the platform comprises an agricultural agent taught herein within the platform. In some embodiments, the platform is stabilized by an addition of a stabilizing agent s selected from a pH regulator, a non-ionic surfactant and a crosslinker agent described in Table 1.

In some embodiments, the at least two biopolymers comprise chitosan and alginate. In some embodiments, the at least two biopolymers comprise chitosan and dextran sulfate.

In some embodiments, the agricultural agent is an agrochemical, a biologically active agent, or an agricultural product taught herein.

In some embodiments, the layer-by-layer assembly comprises at least 2, 3, 4, 5, 6, or more layers. In some embodiments, the coating platform forms a macromolecular structure. In some embodiments, the macromolecular structure is a thin film, a nanoparticle, a molecular aggregate or a microcapsule. In some embodiments, the platform is in the form of an emulsion, a film, a spray coating, a dip coating, a dissolution, or a combination thereof.

### Agricultural Agents

The present disclosure provides coating platforms, compositions, formulations, methods for preparing a multilayer structure on an agricultural agents and products. In some embodiments, the agricultural agent is an agrochemical, a biologically active agent, or an agricultural product.

The present disclosure teaches that the agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

In other embodiments, the agricultural agent is a nucleic acid, a polypeptide, a metabolite, a semiochemical, an essential oil, or a small molecule. In some embodiments, the nucleic acid is a DNA, an RNA, a PNA, or a hybrid DNA-RNA molecule. In some embodiments, the RNA is a messenger RNA (mRNA), a guide RNA (gRNA), or an inhibitory RNA. In some embodiments, the inhibitory RNA is RNAi, shRNA, or miRNA. In some embodiments, the inhibitory RNA inhibits gene expression in a plant. In some embodiments, the inhibitory RNA inhibits gene expression in a plant symbiont.

In some embodiments, the nucleic acid is an mRNA, a modified mRNA, or a DNA molecule that, in the plant, increases expression of an enzyme, a pore-forming protein, a signaling ligand, a cell penetrating peptide, a transcription factor, a receptor, an antibody, a nanobody, a gene editing protein, a riboprotein, a protein aptamer, or a chaperone.

In some embodiments, the nucleic acid is an antisense RNA, a siRNA, a shRNA, a miRNA, an aiRNA, a PNA, a morpholino, a LNA, a piRNA, a ribozyme, a DNAzyme, an aptamer, a circRNA, a gRNA, or a DNA molecule that, in the plant, decreases expression of an enzyme, a transcription factor, a secretory protein, a structural factor, a riboprotein, a protein aptamer, a chaperone, a receptor, a signaling ligand, or a transporter.

In some embodiments, the polypeptide is an enzyme, pore-forming protein, signaling ligand, cell penetrating peptide, transcription factor, receptor, antibody, nanobody, gene editing protein, riboprotein, a protein aptamer, or chaperone.

A description of agricultural agents and active ingredients can be found, for example, in International Patent application Nos. WO2018/201160, WO2018/201161, WO2019/060903, and WO2021/133846, all of which are incorporated herein by reference.

### Agrochemical

In some embodiments, the agricultural agent is an agrochemical.

The term “agrochemical” as used herein means a chemical substance, whether naturally or synthetically obtained, which is applied to a plant, to a pest or to a locus thereof to result in expressing a desired biological activity. The term “biological activity” as used herein means elicitation of a stimulatory, inhibitory, regulatory, therapeutic, toxic or lethal response in a plant or in a pest such as a pathogen, parasite or feeding organism present in or on a plant or the elicitation of such a response in a locus of a plant, a pest or a structure. The term “plant” includes but shall not be limited to all food, fiber, feed and forage crops (pre and post harvest, seed and seed treatment), trees, turf and ornamentals. Examples of agrochemical substances include, but are not limited to, chemical pesticides (such as herbicides, algicides, fungicides, bactericides, viricides, insecticides, acaricides, miticides, rodenticides, nematicides and molluscicides), herbicide safeners, plant growth regulators (such as hormones and cell grown agents; including abscisic acid, auxin, brassinosteroid, cytokinin, ethylene, gibberellin, jasmonate, salicylic acid, strigolactone, plant peptide hormones, polyamine, nitric oxide, karrikin, triacontano etc.), fertilizers, soil conditioners, and nutrients, gametocides, defoliants, desiccants, mixtures thereof.

In some embodiments, the agrochemicals are synthetic or synthetically obtained. In other embodiments, the agrochemicals are naturally occurring or naturally obtained.

More examples of the above-described agrochemicals are described, for example, in U.S. Patent Application No. 2012/0016022, which is incorporated by reference herein in its entirety.

### Biologically Active Agents

In some embodiments, the agricultural agent is a biologically active agent.

The term “biologically active agent” (synonymous with “bioactive agent”) indicates that an agent, a composition or compound itself has a biological effect, or that it modifies, causes, promotes, enhances, blocks, reduces, limits the production or activity of, or reacts with or binds to an endogenous molecule that has a biological effect. A “biological effect” may be but is not limited to one that impacts a biological process in/onto a plant; one that impacts a biological process in a pest, pathogen or parasite; one that generates or causes to be generated a detectable signal; and the like. Biologically active agents, compositions, complexes or compounds may be used in agricultural applications and compositions. Biologically active agents, compositions, complexes or compounds act to cause or stimulate a desired effect upon a plant, an insect, a worm, bacteria, fungi, or virus. Non-limiting examples of desired effects include, for example, (i) preventing, treating or curing a disease or condition in a plant suffering therefrom; (ii) limiting the growth of or killing a pest, a pathogen or a parasite that infects a plant; (iii) augmenting the phenotype or genotype of a plant; (iv) stimulating a positive response in a plant to germinate, grow vegetatively, bloom, fertilize, produce fruits and/or seeds, and harvest; and (v) controlling a pest to cause a disease or disorder.

In the context of agricultural applications of the present disclosure, the term “biologically active agent” indicates that the agent, composition, complex or compound has an activity that impacts vegetative and reproductive growth of a plant in a positive sense, impacts a plant suffering from a disease or disorder in a positive sense and/or impacts a pest, pathogen or parasite in a negative sense. Thus, a biologically active agent, composition, complex or compound may cause or promote a biological or biochemical activity within a plant that is detrimental to the growth and/or maintenance of a pest, pathogen or parasite; or of cells, tissues or organs of a plant that have abnormal growth or biochemical characteristics and/or a pest, a pathogen or a parasite that causes a disease or disorder within a host such as a plant.

In some embodiments, the biologically active agent is a natural product derived from a living organism. In some embodiments, the biologically active agent is a nucleic acid, a polypeptide, a metabolite, a semiochemical (such as pheromone), or an essential oil, which is a natural/naturally-occurring product or identical to a natural product. In some embodiments, the biologically active agents comprise biocontrols and biostimulants described below.

As one example of the biologically active agents, essential oils (EOs) such as peppermint oil (PO), thyme oil (TO), clove oil (CO), lemongrass oil (LO) and cinnamon oil (CnO) have been used for their antibacterial, antiviral, anti-inflammatory, antifungal, and antioxidant properties. Terpenoids such as menthol and thymol and phenylpropenes such as eugenol and cinnamaldehyde are components of EOs that mainly influence antibacterial activities. For example, thymol is able to disturb micromembranes by integration of its polar head-groups in lipid bilayers and increase of the intracellular ATP concentration. Eugenol was also found to affect the transport of ions through cellular membranes. Cinnamaldehyde inhibits enzymes associated in cytokine interactions and acts as an ATPase inhibitor.

In some embodiments, terpenes are chemical compounds that are widespread in nature, mainly in plants as constituents of essential oils (EOs). Their building block is the hydrocarbon isoprene (C5H8)n.

In some embodiments, examples of terpenes include, but are not limited to citral, pinene, nerol, b-ionone, geraniol, carvacrol, eugenol, carvone, terpeniol, anethole, camphor, menthol, limonene, nerolidol, framesol, phytol, carotene (vitamin A1), squalene, thymol, tocotrienol, perillyl alcohol, borneol, myrcene, simene, carene, terpenene, linalool and mixtures thereof. In some embodiments, the essential oil comprises geraniol, eugenol, genistein, carvacrol, thymol, pyrethrum or carvacrol.

In some embodiments, the essential oils can include oils from the classes of terpenes, terpenoids, phenylpropenes and combinations thereof. Essential oils as provided herein also contain essential oils derived from plants (i.e., “natural” essential oils) and additionally or alternatively their synthetic analogues.

It should be noted that terpenes are also known by the names of the extract or essential oil which contain them, e. g. peppermint oil (PO), thyme oil (TO), clove oil (CO), lemongrass oil (LO) and cinnamon oil (CnO).

In some embodiments, the biologically active agent is a nutrient including carbohydrates, fats, fiber, minerals, proteins, carbohydrates, fibers, vitamins, antioxidants, essential oils, and water. Examples of key nutrients for animal health can be classified as (i) proteins and amino acids (such as arginine, histidine, isoleucine, leucine, lysine, methionine, phenylalanine, threonine, tryptophan, valine, taurine, collagen and gelatin), (ii) fats (such as triglycerides, omega-3, omega-6, or omega-9 fatty acids, linoleic acid, tocopherols, arachidonic acid, docosahexaenoic acid (DHA), eicosapentaenoic acid (EPA)), (iii) carbohydrates (glucose, galactose, and fructose, lactose, disaccharides and oligosaccharides), (iv) fibers (cellulose and its derivatives, polysaccharides, and glycosaminoglycans), (v) vitamins (A, B-complex, D, C, E, K, thiamine and β-carotene), (vi) minerals (macrominerals such as sodium, potassium, calcium, phosphorus, magnesium), (vii) trace minerals of known importance such as iron, zinc, copper, iodine, fluorine, selenium, chromium, (viii) other minerals useful for animal nutrition such as cobalt, molybdenum, cadmium, arsenic, silicon, vanadium, nickel, lead, tin and (ix) antioxidants such as ascorbic acid, polyphenols, tannins, flavonols and triterpenes glucosides.

By way of non-limiting example, the biologically active agent or compound is a nucleic acid, a polypeptide, a metabolite, a semiochemical or a micronutrient. These biologically active agents can be broadly categorized as biocontrols and biostimulants.

### (i) Biocontrols

The present disclosure teaches the biologically active agents as a biocontrol including, but are not limited to, a pesticide, an insecticide, a herbicide, a fungicide, a nematicide, an essential oil, an antimicrobial agent, an antifungal agent, and an antiviral agent.

In some embodiments, a pesticide, an insecticide, a herbicide, a fungicide, a nematicide, an antimicrobial agent, an antifungal agent, and an antiviral agent are natural products or naturally occurring agents produced by a living organism.

The present disclosure teaches the biologically active agents as a biocontrol including, but are not limited to, RNAi, protoxins, metabolites, antibodies, fermentation products, hormones, pheronomes, and semiochemicals. In some embodiments, biochemical control agents include, but are not limited to, semichemicals for example, plant-growth regulators, hormones, enzymes, pheromones, allomones and kairomones, which are either naturally occurring or identical to a natural product, that attract, retard, destroy or otherwise exert a pesticidal activity. In the some embodiments, biocontrols refer to biologically active compounds a polypeptide, a metabolite, a semiochemical, a hormone, a pheromone, and a nucleic acid such as RNA biomolecule including antisense nucleic acid, dsRNA, shRNA, siRNA, miRNA, ribozyme, and aptamer.

In some embodiments, semiochemicals includes pheromones, allomones, kairomones, and synomones. For example, pheromones, a class of microbial volatile organic compounds, can act as attractants and repellents to insects and other invertebrates. They can be used as biocontrol agents to control various pathogens as well as biofertilizers used for plant growth promotion. They are even used postharvest to prevent plant disease (Kanchiswamy et al., Trends Plant Sci. 40(4):206-211, 2015). Pheromones can be naturally produced or synthetically produced. Pheromones can be used for plant growth promotion. Some pheromones, derived from microorganisms, are able to promote the growth of some plants under various stressful conditions. For example, 2,3 butanediol, which is derived from the genus Bacillus) has been shown to induce systemic resistance and promote the growth of plants under stressful conditions like high salinity (Ryu et al., Plant Physiol. 134(3):1017-1026, 2004; Ryu et al., PNAS 100(8):4927-2932, 2003). Pheromones can be also used for pest management. Certain pheromones, usually derived from insects, are able to be used as biocontrol agents. They can be a part of a formulation that can attract and kill the target pest or they can be used for “mass-trapping of pest populations (Witzgall et al., J Chem Ecol. 36(1):80-100, 2010). For example, pheromones ((Z)-9-hexadecenal, (Z)-11-hexadecenal and (Z)-9-octadecenal, components of the S. incertulas pheromone) have been demonstrated to be able to control the population of yellow stem borer (Scirpophaga incertulas) on rice (Cork et al., Bulletin of Entomological Research, 86(5):515-524).

### (ii) Biostimulants

The present disclosure teaches the biologically active agents as a biostimulant. Non-limiting examples of these biostimulants include hormones and biochemical growth agents. These actives include abscisic acid (involved in dormancy mechanisms under stress), auxins (positively influence plant growth), cytokinins (influence cell division and shoot formation), ACC Deaminase (lowers inhibitory growth effects of ethylene), gibberellins (positively influence plant growth by elongating stems and stimulating pollen tube growth), and many others (brassinosteroids, salicylic acid, jasmonates, plant peptide hormones, polyamines, nitric oxide, strigolactones, karrikins, and triacontanol), which are used to both positively and negatively regulate the growth of plants.

In some embodiments, the biologically active compounds are pheromones to improve and modify chemical reactions to help the plants grow and fight stresses as biostimulants.

In some embodiments, the biologically active agents are fertilizers, plant micronutrients and plant macro-nutrients, which include, but are not limited to, nitrogen, potassium, and phosphorous, and trace nutrients such as iron, copper, zinc, boron, manganese, calcium, molybdenum, and magnesium.

In some embodiments, biostimulants comprises microbial properties such as rhizobium (PGPRs) properties, fungal properties, cytokinins, phytohormones, peptides, and ACC-Deaminase. For example, nitrogen fixation can be achieved by delivering deliver ureases and/or nitrogenases via minicells to assist with nitrogen fixation.

In some embodiments, biostimulants comprises acids (such as humic substances, humin, fulvic acids, B vitamins, amino acids, fatty acids/lipids), extracts (such as carboxyls, botanicals, allelochemicals, betaines, polyamines, polyphenols, chitosan and other biopolymers), phosphites, phosphate solubilizers, nitrogenous compounds, inorganic salts, protein hydrolysates, and beneficial elements.

As one example, protein hydrolysates have potential to increase germination, productivity and quality of wide range of crops. Protein hydrolysates can also alleviate negative effects of salinity, drought, and heavy metals. Protein hydrolysates can stimulate carbon and nitrogen metabolism, and interfering with hormonal activity. Protein hydrolysates can enhance nutrient availability in plant growth substrates and increase nutrient uptake and use efficiency in plants. Protein hydrolysates can also stimulate plant microbiomes; substrates such as amino acids provided by protein hydrolysates could provide food source for plant-associated microbes.

Biostimulants foster plant development in a number of demonstrated ways throughout the crop lifecycle, from seed germination to plant maturity. They can be applied to plant, seed, soil or other growing media that may enhance the plant's ability to assimilate nutrients and properly develop. By fostering complementary soil microbes and improving metabolic efficiency, root development and nutrient delivery, biostimulants can increase yield in terms of weight, seed and fruit set, enhance quality, affecting sugar content, color and shelf life, improve the efficiency of water usage, and strengthen stress tolerance and recovery. These biostimulants can include pheromones or enzymes like ACC-Deaminase.

Biostimulants are compounds that produce non-nutritional plant growth responses and reduce stress by enhancing stress tolerance. Fertilizers, which produce a nutritional response can be considered as biostimulants. Many important benefits of biostimulants are based on their ability to influence hormonal activity. Hormones in plants (phytohormones) are chemical messengers regulating normal plant development as well as responses to the environment. Root and shoot growth, as well as other growth responses are regulated by phytohormones. Compounds in biostimulants can alter the hormonal status of a plant and exert large influences over its growth and health. Sea kelp, humic acids and B Vitamins are common components of biostimulants that are important sources of compounds that influence plant growth and hormonal activity. Antioxidants are another group of plant chemicals that are important in regulating the plants response to environmental and chemical stress (drought, heat, UV light and herbicides). When plants come under stress, “free radicals” or reactive oxygen molecules (e.g., hydrogen peroxide) damage the plants cells. Antioxidants suppress free radical toxicity. Plants with the high levels of antioxidants produce better root and shoot growth, maintain higher leaf-moisture content and lower disease incidence in both normal and stressful environments. Applying a biostimulant enhances antioxidant activity, which increases the plant's defensive system. Vitamin C, Vitamin E, and amino acids such as glycine are antioxidants contained in biostimulants.

Biostimulants may act to stimulate the growth of microorganisms that are present in soil or other plant growing medium. Biostimulants are capable of stimulating growth of microbes included in the microbial inoculant. Thus, it is desirable to obtain a biostimulant, that, when used with a microbial inoculant, is capable of enhancing the population of both native microbes and inoculant microbes.

### Active Agent Carriers

The present disclosure teaches that the agrochemical is loaded into a microparticle. In some embodiments, the biologically active agent is loaded into a microparticle.

Microparticles are particles between 1 and 1000 μm in size. Commercially available microparticles are available in a wide variety of materials, including ceramics, glass, polymers, and metals. Microspheres are spherical microparticles, In biological systems, a microparticle may be synonymous with a microvesicle, a type of extracellular vesicle (EV).

The microparticles of the present disclosure can comprise a variety of such particles, including, but not limited to, minicells, microcapsules, microspheres, liposomes, yeast cell particles, glucan particles, and the like, and mixtures thereof. In order to achieve the high loading of active agent that is an essential element of the present invention, it is desirable that the microparticles as hereinbefore described comprise hollow microparticles. In a particular aspect of the invention the microparticles comprise hollow yeast cell particles or hollow glucan particles.

Microparticles may comprise microcapsules and/or microspheres, usually consisting of substantially spherical particles, for example, 2 mm or less in diameter, usually 500 μm or less in diameter. If the particles are less than 1 μm in diameter they are often referred to as nanocapsules or nanospheres. Microcapsules and microspheres can generally be distinguished from each other by whether a agricultural agent is formed into a central core surrounded by an encapsulating structure of a matrix material (microcapsules) or whether an agricultural agent is dispersed throughout the matrix material particle (microspheres). It should be understood that it is within the scope of the present invention to include active agents which are encapsulated within the structure of a matrix material and active agents which are dispersed throughout a matrix material.

A description of methods of making and using microspheres and microcapsules can be found, for example, in International Patent application No. WO 09/013361, which is incorporated herein by reference.

The microparticles or the microspheres of the present disclosure have an average geometric particle size of less than 200 microns. The particle size is from about 0.01 μm to about 200 μm, from about 0.1 μm to about 100 μm, from about 0.5 μm to about 50 μm, and from about 0.5 μm to about 10 μm, as measured by dynamic light scattering methods (e.g., photocorrelation spectroscopy, laser diffraction, low-angle laser light scattering (LALLS), medium-angle laser light scattering (MALLS)), by light obscuration methods (Coulter analysis method, for example) or by other methods, such as rheology or microscopy (light or electron).

The present disclosure teaches that said microparticle comprises a minicell or a colloidal carrier.

The term “minicell” in this disclosure refers to the result of aberrant, asymmetric cell division, and contain membranes, peptidoglycan, ribosomes, RNA, protein, and often plasmids but no chromosome. Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate or may be introduced into minicells after segregation from parent cells. In some embodiments, the minicells described herein are naturally occurring. In other embodiments, the minicells described herein are non-naturally occurring. In some embodiments, minicells can be loaded with the biologically active agents described herein.

Minicells are derivatives of cells that lack chromosomal DNA and which are sometimes referred to as anucleate cells. Because eubacterial and archeabacterial cells, unlike eukaryotic cells, do not have a nucleus (a distinct organelle that contains chromosomes), these non-eukaryotic minicells are more accurately described as being “without chromosomes” or “achromosomal,” as opposed to “anucleate.” Nonetheless, those skilled in the art often use the term “anucleate” when referring to bacterial minicells in addition to other minicells. Accordingly, in the present disclosure, the term “minicells” encompasses derivatives of eubacterial cells that lack a chromosome; derivatives of archeabacterial cells that lack their chromosome(s), and anucleate derivatives of eukaryotic cells.

A description of minicells and methods of making and using such minicells can be found, for example, in International Patent application Nos. WO2018/201160, WO2018/201161, WO2019/060903, and WO2021/133846, all of which are incorporated herein by reference.

The term “colloidal carriers” or “a colloidal carrier” effectively allow for the transportation of an active ingredient to the target site within the plant. They can modify the distribution of an associated substance, allowing controlled release and site-specific delivery of active ingredients. Colloidal carriers can include liposomes, niosomes, microspheres, nanospheres, microcapsules, nanocapsules and emulsions. In some embodiments, colloidal carriers such as liposomes, niosomes, nanospheres, microcapsules, nanocapsules and emulsions can be loaded with the biologically active agents described herein.

Payloads encapsulated in the capsules may be selected from a wide variety of agents, e.g., including biological cells (including, e.g., bacteria, archaea, eukaryota), biomolecules (including, e.g., enzyme, protein, carbohydrate, lipid, nucleic acid), agricultural agents including synthetic agrochemicals and biologically active agents taught herein. Agricultural agents may include, but not limited to, antibiotics, antivirals, antifungals, nucleic acids, plasmids, siRNAs, miRNA, antisense oligos, DNA binding compounds, hormones, vitamins, proteins, peptides, polypeptides. a pesticide, an insecticide, a herbicide, a fungicide, a nematicide, and an essential oil.

In some embodiments, the agricultural agent is an agricultural product or produce. The agricultural product is selected from a seed, a grain, a fruit, a seedling, a leafy vegetable , a fresh-cut plant produce, and an edible part of a plant.

In some embodiments, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90% of the agricultural agent that loaded/encapsulated with a microparticle (such as minicell or a colloidal carrier) is coated by biopolymers. In further embodiments, at least about 50%, at least about 60%, at least about 70%, or at least about 80% of the agricultural agent that loaded/encapsulated into a microparticle (such as a minicell or a colloidal carrier) is coated by biopolymers.

In other embodiments, the biopolymers stabilize agricultural agents and/or the agricultural agents loaded into microparticles (such as minicells or colloidal carriers) at least one hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 18 hours, at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20, at least 21 days, at least 22 days, at least 23 days, at least 24 days, at least 25 days, at least 26 days, at least 27 days, at least 28 days, at least 29 days, at least 30 days, at least 31 days, at least 32 days, at least 33 days, at least 34 days, at least 35 days, at least 36 days, at least 37 days, at least 38 days, at least 39 days, at least 40 days, at least 45 days, at least 50 days, at least 55 days, or at least 60 days, at room temperature.

In some embodiments, the biopolymers stabilize the agricultural agents and/or the agricultural agents loaded into microparticles (such as minicells or colloidal carriers) in a thermal variation. In some embodiments, the agent coated by the biopolymers is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to thermal degradation than a free active agent not coated by the biopolymers after a heat treatment. In other embodiments, the heat or cold treatment is above room temperature, which is about at 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., or higher.

In other embodiments, the agent or the microparticle encapsulating the agent coated by the biopolymers is at least 1.1-fold more resistant to thermal degradation than a free active agent not coated by the biopolymers after a heat treatment.

In some embodiments, the biopolymers protects the agricultural agents and/or the agricultural agents loaded into microparticles, such as minicells or colloidal carriers, from oxidative degradation by ultraviolet (UV) or visible light. In some embodiments, the agent coated by the biopolymers is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to oxidative degradation than a free active agent not coated by the biopolymers under UV or visible light exposure.

In some embodiments, the biopolymers protect the agricultural agents and/or the agricultural agents loaded with microparticles, such as minicells or colloidal carriers, from humidity. In some embodiments, the coating of the multilayered biopolymers can prevent the agents from an environment of high-humidity.

Among the various aspects of the present disclosure, a biopolymer is present in the form of coating or encapsulation of an agricultural agent or an agricultural agent loaded into a microparticle, such as a minicell or a colloidal carrier, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10% or more by weight of the biopolymer-coated agricultural agent or the biopolymer-coated a microparticle encapsulating the agricultural agent.

In some embodiments, the agricultural agents or agricultural active ingredients are directed coated, covered, protected or encapsulated by a biopolymer layer taught herein.

In further embodiments, the agricultural agents or agricultural active ingredients are loaded into microparticles (such as minicells, colloidal carriers) and the agent-loaded microparticles are coated, covered, protected or encapsulated by a biopolymer layer taught herein. In further embodiments, the surface of the agent-loaded microparticles are coated, covered, protected or encapsulated by a biopolymer layer taught herein.

The present disclosure teaches that the multilayered biopolymers confer to the agricultural agent, produce, or product an improved stability, an enhanced bioavailability and an extended shelf life. The present disclosure teaches a composition comprising the coating platform (e.g. multilayered biopolymer) and the agricultural agent and product, thereby conferring to an improved stability, an enhanced bioavailability and an extended shelf life.

### Controlled Release of Biologically Active Agents Coated by Polymer Coating Platform

The present disclosure teaches that biologically active agents encapsulated or coated by the polymer coating platform for agricultural applications. In some embodiments, the polymer-coated agricultural agents are stabilized and protected from environmental hazards. In some embodiments, the polymer-coated agricultural agents are also delivered to a subject and released in a controlled manner. The polymer coating platforms, matrices, structures, or scaffolds retain the desired effects of the agricultural agents over a longer period of time.

The term “controlled release” as used herein means that one or more agricultural agents encapsulated or coated by biopolymer(s) described in the present disclosure is released over time in a controlled manner. The controlled release is meant for purposes of the present disclosure that, once the agent is released from the polymer-coated composition or formulation, it is released at a controlled rate such that levels and/or concentrations of the compounds are sustained and/or delayed over an extended period of time from the start of compound release, e.g., providing a release over a time period with a prolonged interval.

If it is desired to permit fast release of the polymer-coated composition, it is necessary to have thin walled microparticles (including minicells, liposomes, colloidal carriers or microcapsules) comprising one or more agricultural agents. Greater quantities of polymer will slow the release rate. The diameter of the microparticles (including minicells, liposomes, colloidal carriers and microcapsules and the quantity of wall forming polymer can be used to tune the performance of the microparticles, such as minicells, liposomes, colloidal carriers and microcapsules, depending on the required agents and the conditions of use.

The increasing use of agrochemicals such as pesticides, herbicides, fungicides, insecticides, nematicides, fertilizer and the like, poses health and environmental problems which need to be controlled in order to minimize the harmful effects of those products. Leaching and migration of agrochemicals results in loss of herbicidal efficiency and can cause damage to other crops and contaminate water. In some embodiments, the polymer-coated agents can control and/or delay release rate of agricultural agents taught herein.

The present disclosure teaches that agricultural agents coated by biopolymer(s) disclosed herein can be released in a controlled manner. In some embodiments, the controlled release of the compounds are determined by a treatment of the agents. In some embodiments, a varying concentration of the agent can prevent the degradation of the polymer coating platform protecting the agricultural agents taught herein in different degrees.

In some embodiments, an agricultural agent coated by multilayered polymers disclosed herein can be released at a rate of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95%, or 100% of its desired unit/input per day. In other embodiments, an amount of the polymer unit/input accounts for the coated agents. Encapsulation amount of agricultural agents can calculate encapsulation fraction and mass fraction, which determines the desired polymer unit and/or input per day.

In some embodiments, treatment of an agent without multilayered polymers coated may have an initial fast release of about 60%, 70%, 80%, 90% or 100% of its desired unit/input per day. In other embodiments, controlled release of an agent coated with multilayered polymers can give rise to a controlled release of about 1%, 2%, 3%, 4%, 5%, 6%, 7%, 8%, 9%, 10%, 11%, 12%, 13%, 14%, 15%, 16%, 17%, 18%, 19%, 20%, 30%, 40%, 50%, 60%, 70%, 80%, 90%, 95% or 100% of the desired input per day.

In some embodiments, a varying concentration of the polymer can prevent the degradation of the coating platform protecting the agricultural agents in different degrees.

The present disclosure teaches a composition comprising: a multilayered polymer and an agricultural agent. In some embodiments, the agent is coated by at least two biopolymers.

In some embodiments, a release of the agent coated by the biopolymers is delayed when compared to a free agent not coated by the biopolymers.

In some embodiments, a release percentage (%) of the polymer-coated agricultural agent is less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%,or less than about 10% after a release.

The present disclosure teaches that the agricultural agents or minicells encapsulating the agents or colloidal carriers comprising the agents can be coated by biopolymer taught herein.

In some embodiments, the agricultural agent coated by the biopolymer-coated minicell has an extended release with at least about 1%, at least about 5%, at least about 10%, at least about 20%, at least about 30%, at least about 40%, at least about 50%, at least about 60%, at least about 70%, at least about 80%, at least about 90% of the agent retained, when compared to the fully released free agent without the biopolymer(s) coated, over time.

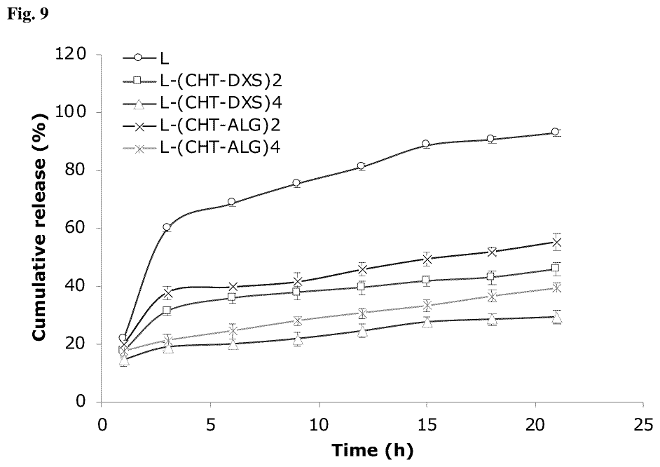

In some embodiments, the liposome containing active agent coated by the multilayered biopolymer has an extended release with at least about 20%, about 30%, about 40%, or about 50% of the agent retained, when compared to the fully-released active agent from the liposome without the biopolymer coated, at 24 hours after the release, as presented in FIG. 9.

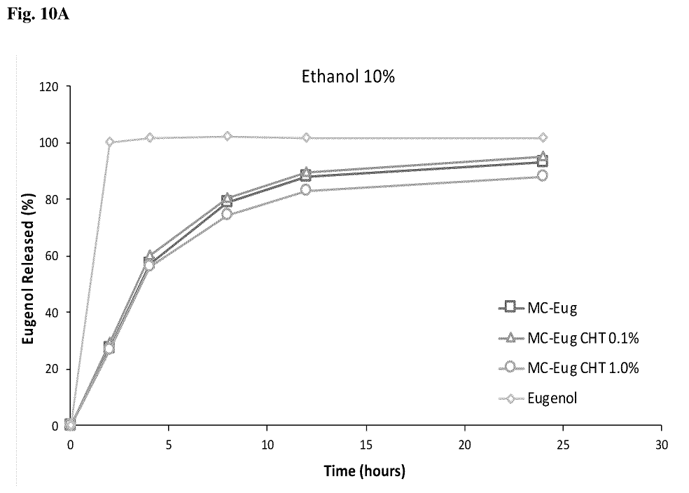

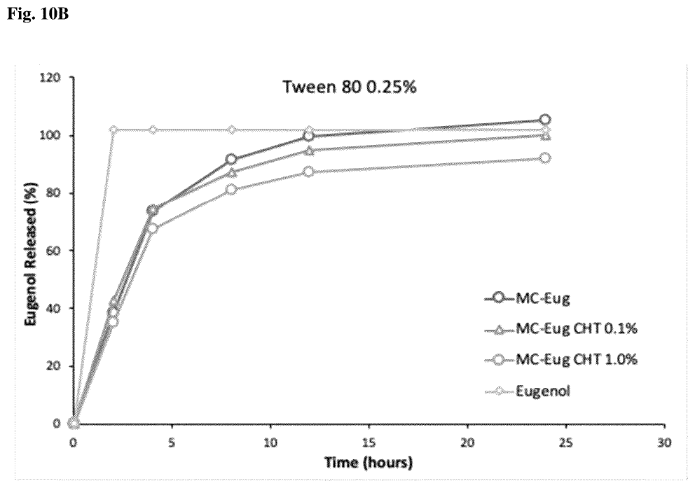

In some embodiments, the minicell-encapsulated active agent (e.g. eugenol) coated by the multilayered biopolymer has an extended release with at least about 50%, at least about 60%, at least about 70%, at least about 80% of the agent retained, when compared to the fully released agent without the biopolymer coated, at 5 hours after the release, as presented in FIG. 10A-10B.

In some embodiments, the active agent encapsulated by the microparticle (minicell or colloidal carrier), which is further coated by biopolymers is capable of being delivered to a target in a controlled release manner.

The present disclosure teaches that the increased number of biopolymer layers can effectively modulate the release of agricultural agents coated by the biopolymer layers. With the higher number of coating layers, the release of agricultural agents coated with the layers is delayed, as presented in FIG. 16. Thus, the release of the active ingredients of interest can be controlled by the number of biopolymer layers added to the active ingredients directly or the active ingredients loaded into a microparticle including, but not limited to, a minicell, a liposome, or a microcapsule.

### Target or Subject of Application of Polymer-Coated Agricultural Agents

As used herein, the term “target” or “subject” is intended to include any target or subject surface to which a compound, a formulation, or a polymer-coated agricultural agent of the present disclosure may be applied, wherein the target or subject is a plant, a pest, a soil, a ground, or an air. For example to a plant, plant material including roots, bulbs, tubers, seedlings, corns, leaves, flowers, seeds, stems, callus tissue, nuts, grains, fruit, cuttings, root stock, scions, harvested crops including roots, bulbs, tubers, corms, leaves, flowers, seeds, stems, callus tissue, nuts, grains, fruit, cuttings, root stock, scions, or any surface that may contact harvested crops including harvesting equipment, packaging equipment and packaging material.

The term “target cell” refers to cells that is a component of each target or subject.

In some embodiments, exemplary crops, according to certain embodiments of the present disclosures, include but not limited to Row crops, specialty crops, commodity crops, and ornamental crops. Examples of row crops include sunflower, potato, sweet potato, canola, dry bean, field pea, flax, safflower, buckwheat, cotton, maize, soybeans, and sugar beets. Examples of commodity crops include maize, soybean and cotton. Examples of ornamental crops include boxwood, christmas trees, greenhouse grown decorative plants.

The present disclosure also teaches exemplary crops as a target, according to certain embodiments of the present disclosure, including vegetables such as broccoli, cauliflower, globe artichoke, peas, beans, kale, collard greens, spinach, arugula, beet greens, bok choy, chard, choi sum, turnip greens, endive, lettuce, mustard, greens, watercress, garlic chives, gai lan, leeks, Brussels sprouts, capers, kohlrabi, celery, rhubarb, cardoon, Chinese celery, lemon grass, asparagus, bamboo shoots, galangal, ginger, soybean, mung beans, urad, carrots parsnips, beets, radishes, rutabagas, turnips, burdocks, onions, shallots, leeks, garlic, green beans, lentils, and snow peas; fruits, such as tomatoes, cucumbers, squash, zucchinis, pumpkins, melons, peppers, eggplant, tomatillos, christophene, okra, breadfruit, avocado, blackcurrant, redcurrant, gooseberry, guava, lucuma, chili pepper, pomegranate, kiwifruit, grapes, cranberry, blueberry, orange, lemon, lime, grapefruit, blackberry, raspberry, boysenberry, pineapple, fig, mulberry, hedge apple, apple, rose hip, and strawberry; nuts such as almonds, pecans, walnuts, brazil nuts, candlenuts, cashew nuts, gevuina nuts, horse-chestnuts, macadamia nuts, Malabar chestnuts, mongongo, peanuts, pine nuts, and pistachios; tubers such as potatoes, sweet potatoes, cassava, yams, and dahlias; cereals or grains such as maize, rice, wheat, barley, sorghum, millet, oats, rye, triticale, fonio, buckwheat, and quinoa; fibers, including, for example, cotton, flax, hemp, kapok, jute, ramie, sisal, and other fibers from plants; stimulant crops, including, for example, coffee, cocoa bean, tea, mate, other plants; and pulses, including, for example, beans (including, for example, kidney, haricot, lima, butter, adzuki, mungo, golden, green gram, black gram, urd, scarlet runner, rice, moth, tepary, lablab, hyacinth, jack, winged, guar, velvet, yam, and other beans), horse-bean, broad bean, field bean, garden pea, chickpea, bengal gram, garbanzo, cowpea, blackeyed pea, pigeon pea, cajan pea, congo bean, lentil, bambara groundnut, earth pea, vetches, lupins, and other pulses.

The present disclosure teaches that a target/subject cell comprises a plant cell, an insect cell, a worm cell, a bacterial cell, a fungal cell, and a virus.

The present disclosure provides that the polymer coating platform comprising agricultural agents, products, and formulation as described herein, is targeted to a plant, an insect, a worm, a bacterium, a fungus, and a virus.

In some embodiments, the target is agricultural pests such as mites, aphids, whiteflies and thrips among the agricultural pests. Examples of other agricultural insect pests than the mites, aphids, whiteflies and thrips include diamondback moth (Plutella xylostella), cabbage armyworm (Mamestra brassicae), common cutworm (Spodoptera litura), codlingmoth (Cydia pomonella), bollworm (Heliothis zea), tobacco budworm (Heliothis virescens), gypsy moth (Lymantria dispar), rice leafroller (Cnaphalocrocis medinalis), smaller tea tortrix (Adoxophyes sp.), Colorado potato beetle (Leptinotarsa decemlineata), cucurbit leaf beetle (Aulacophora femoralis), boll weevil (Anthonomus grandis), planthoppers, leafhoppers, scales, bugs, grasshoppers, anthomyiid flies, scarabs, black cutworm (Agrotis ipsilon), cutworm (Agrotis segetum) and ants.

In addition, examples of other agricultural pests include soil pests, such as plant parasitic nematodes such as root-knot nematodes (Meloidogynidae), cyst nematodes (Heteroderidae), root-lesion nematodes (Pratylenchidae), white-tip nematode (Aphelenchoi desbesseyi), strawberry bud nematode (Nothotylenchus acris) and pine wood nematode (Bursaphelenchus xylophilus); gastropods such as slugs and snails; and isopods such as pill bugs (Armadillidium vulgare) and pill bugs (Porcellio scaber).

Examples of other insect pests include hygienic insect pests such as tropical rat mite (Ornithonyssus bacoti), cockroaches, housefly (Musca domestica) and house mosquito (Culex pipiens pallens); stored grain insect such as angoumois grain moth (Sitotroga cerealella), adzuki bean weevil (Callosobruchus chinensis), red flour beetle (Tribolium castaneum) and mealworms; clothes insect pests such as casemaking clothes moth (Tinea translucens) and black carpet beetle (Attagenus unicolor japonicus); house and household insect pests such as subterranean termites; domestic mites such a mold mite (Tyrophaqus putrescentiae), Dermatophagoides farinae and Chelacaropsis moorei; and hygienic insect pests such as tropical rat mite (Ornithonyssus bacoti).

Insect pests include insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc.

In some embodiments, the insects are selected from cotton bollworm, native budworm, green mirids, aphids, green vegetable bugs, apple dimpling bugs, thrips (plaque thrips, tobacco thrips, onion thrips, western flower thrips), white flies and two spotted mites. In an embodiment the insect pests of animals include fleas, lice, mosquitoes, flies, tsetse flies, ants, ticks, mites, silverfish and chiggers. The above agricultural pests and insect pests are described, for example, in U.S. Patent Application Nos. 2012/0016022 and 2016/0174571, which are incorporated by reference herein in their entirety.

### Use of Biopolymer Coating Platform for Agricultural Products

The present disclosure teaches that the multilayered polymer platform can be used to coat agricultural products or produces (e.g. a seed, a grain, a fruit, a leaf, etc.) with antimicrobial, antifungal, antibacterial properties for fresh produce packaging. The coating platform can provide an extended shelf life of fresh agricultural products or produces. In some embodiments, said agricultural product or produce is a seed, a grain, a fruit, a seedling, a leafy vegetable, a fresh-cut plant produce, or an edible part of a plant.

In some embodiments, the multilayered polymer platform taught herein provides a non-toxic, biodegradable means to enhance value of agricultural produces and products in the field of fresh produce package.

### Methods of Preparing Multilayered Polymer Compositions

The present disclosure teaches that a method of preparing multilayered polymer compositions is by the alternating layer-by-layer deposition method. The method of alternating exposure of the substrate or material to be coated is by alternate immersion in polyelectrolyte solutions, or alternate spraying of polyelectrolyte solutions. The alternating polyelectrolyte layering method does not generally result in a layered morphology of the polymers with the film. Rather, the polymeric components interdiffuse and mix on a molecular level upon incorporation into the thin film. See Losche et al., Macromolecules 31, 8893 (1998). Thus, the polymeric components form a true molecular blend with intimate contact between polymers driven by the multiple electrostatic complexation between positive and negative polymers.

In some embodiments, multilayered polymer compositions are formed by mixing solutions of positive and negative polyelectrolyte. Although there is extensive intermingling of neighboring layers over a range of 4-6 nominal layers, it is possible to obtain actual layers of different composition, or strata, by interspersing several layers made from one pair of polyelectrolytes by several layers made from a different pair. See Losche et al., Macromolecules 31, 8893 (1998). For example, if polymers A and C are positively charged and polymers B and D are negatively charged, about 3 or 4 pairs of A/B layers followed by about 3 or 4 pairs of A/D or C/D layers will produce two strata of distinct composition.

Alternatively, the thin film coating may be applied to a surface using a pre-formed polyelectrolyte complex. See Michaels, Polyelectrolyte Complexes, Ind. Eng. Chem. 57, 32-40 (1965) and Michaels (U.S. Pat. No. 3,467,604). This is accomplished by mixing the oppositely-charged polyelectrolytes to form a polyelectrolyte complex precipitate which is then dissolved or re-suspended in a suitable solvent/liquid to form a polyelectrolyte complex solution/dispersion. The polyelectrolyte complex solution/dispersion is then applied to the substrate surface and the solvent/liquid is evaporated, leaving behind a film comprising the polyelectrolyte complex. To aid in dissolution or dispersion of the complex, both a salt, such as sodium bromide, and an organic solvent, such as acetone is optionally added to the solution comprising the precipitated complex.

In some embodiments, the polyelectrolyte complex comprising the interpenetrating network of at least one predominantly positively charged polyelectrolyte and at least one negatively charged polyelectrolyte are depositing by alternating contact of a polyelectrolyte solution comprising at least one predominantly positively charged polyelectrolyte and a polyelectrolyte solution comprising at least one predominantly negatively charged polyelectrolyte.

Electrostatic layer-by-layer self-assembly techniques have been described (See, e.g., Decher, Science 277, 1232-1237 (1997); Caruso et al., Science 282, 1111-1114 (1998)) that allows the creation of ultra-thin functional films (See, e.g., Schneider and Decher, Nano Lett. 4, 1833-1839 (2004); Schneider et al., Nano Lett. 6, 530-536 (2006); Gittins and Caruso, Adv. Mater. 12, 1947 (2000); Gittins and Caruso, J. Phys. Chem. B 105, 6846-6852 (2001); Thunemann et al., Langmuir 22, 2351-2357 (2006). In some embodiments, the biofunctionality of the films may be altered by deposition of functional polyelectrolytes or biomacromolecules on film surfaces (See, e.g., Wang et al., Nano Lett. 2, 857-861 (2002); Kato and Caruso, J. Phys. Chem. B 109, 19604-19612 (2005).

In some embodiments, provided herewith is a method of preparing a multilayered polymer composition for encapsulation and delivery of an agricultural agent, said method comprising the steps of: a) providing a pair of polymers, wherein a first polymer comprises a cationic polymer and a second polymer comprises an anionic polymer; b) allowing layer-by-layer assembly of said first polymer and said second polymer; c) optionally, adding a stabilizing agent to said layer-by-layer assembly d) coating the agricultural agent with said layer-by-layer assembly. In some embodiments, said two polymers are assembled by a noncovalent bond.

In some embodiments of the methods, said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride). In other embodiments of the methods, said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate. In some embodiments, said cationic polymer comprise chitosan. In other embodiments, said anionic polymer comprise alginate or dextran sulfate. In further embodiments of the methods, said stabilizing agent is selected from a pH regulator, a non-ionic surfactant and a crosslinker agent as presented in Table 1. In some embodiments of the methods, said agricultural agent is an agrochemical, a biologically active agent, or an agricultural product taught herein.

In some embodiments of the methods, the coating of the agricultural agent with the layer-by-layer assembly increases stability of the agricultural agent from an environmental hazard. In some embodiments of the methods, the coating of the agricultural agent with the layer-by-layer assembly promotes controlled release of the agricultural agent.

The present disclosure also teaches a method of producing a polymer-coated agricultural agent, the method comprising the steps of: a. providing an agricultural agent taught herein; b. contacting said agricultural agent with a cationic polymer taught herein; c. contacting said agricultural agent with an anionic polymer taught herein; and to thereby produce said polymer-coated agricultural agent taught herein.

The present disclosure teaches that the biopolymer coating platform can be applied to encapsulation and preservation of agricultural agents of interest for agricultural applications. The biopolymer-coated agricultural agents and produces/produces show improved stability and their biodegradability, biocompatibility, bioavailability, long lasting shelf-life and controlled release properties.

### EXAMPLES

The following examples are given for the purpose of illustrating various embodiments of the disclosure and are not meant to limit the present disclosure in any fashion. Changes therein and other uses which are encompassed within the spirit of the disclosure, as defined by the scope of the claims, will occur to those skilled in the art.

The use of AgriShell technology for different agricultural applications will be detailed in the following examples. As used herein, the term “AgriShell” technology refers to a biodegradable, bioactive and controlled release promoting technology based on a composite nanocoating formulated by alternating layers of biopolymers self-assembled by non-covalent interactions. AgriShell can be interchangeably used with a multilayered polymer composition taught herein, which is a coating platform comprising a layer-by-layer assembly of biopolymers.

### Example 1. Use of AgriShell Technology for Stabilization of Agricultural Active Ingredient Loaded into Liposome Core Formulation

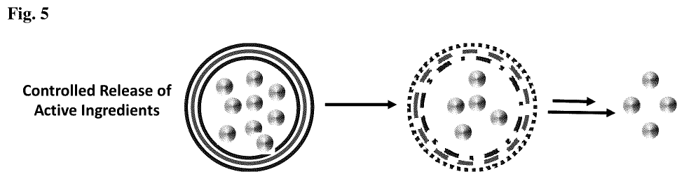

AgriShell technology can act as a functional coating for protecting different agricultural formulations, such as free active ingredients, microencapsulated systems, nanoparticles and emulsions, among others. The selected liposome formulation acts as a core template in this Example and the AgriShell acts as surface nanocoating. The AgriShell allows casting of as many coating layers as required, via layer-by-layer self-assembly, to provide the desired performance or features such as environmental stability (from UV radiation, heat, humidity) and/or controlled release of agricultural formulations as shown in FIG. 5.

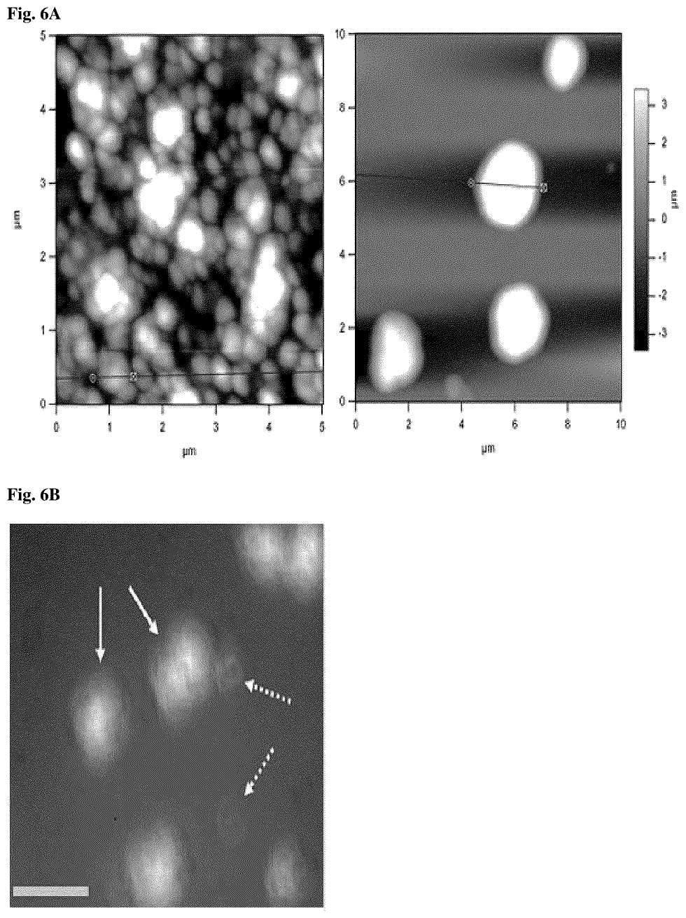

To assess the predicted behavior of AgriShell as functional coating of active agricultural formulations, a model agricultural formulation based on liposomes was coated by AgriShell technology. First, the coating mechanism between the core template selected (liposomes) and AgriShell was tested and optimized. The physical appearance of AgriShell-coated liposome template was examined by Atomic Force Microscopy (AFM) imaging analysis. FIG. 6A shows homogenous spherical shaped nanoparticles (with homogeneity of diameters) and low nanoparticle aggregation. Likewise, the first layer of AgriShell, corresponding to chitosan (CHT) biopolymer, was fluorescently labeled with fluorescein and the efficacy of the nanocoating was followed by fluorescent microscopy, as shown in FIG. 6B, where solid arrows indicate liposomes efficiently coated by fluorescent CHT and dashed arrows indicate un-coated liposomes.

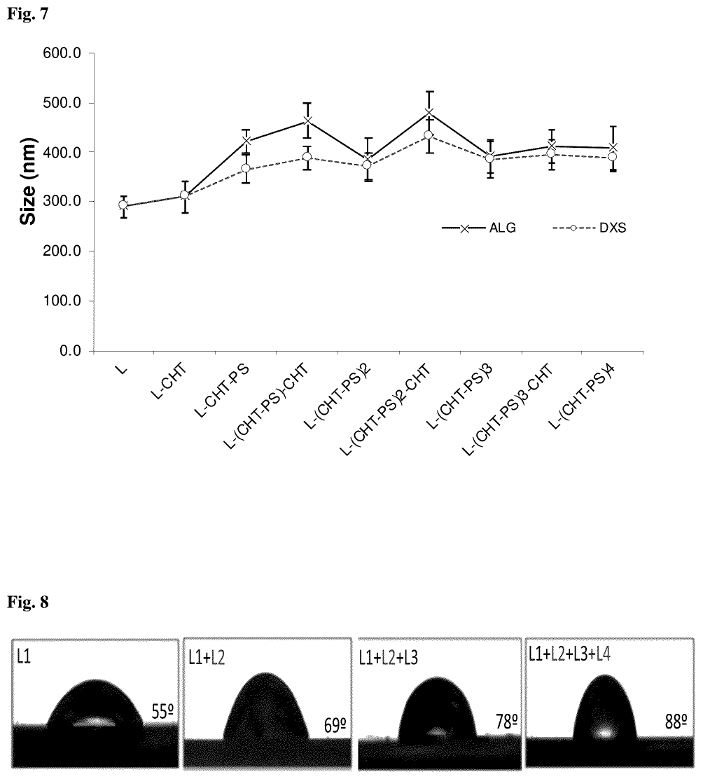

The effect of increasing number of layers of AgriShell casted onto liposome formulation template was followed by monitoring changes on particle size (FIG. 7), surface tension (FIG. 8) and controlled release of model active ingredient loaded into the liposome template formulation (FIG. 9).

Layer-by-layer self-assembly mechanism of AgriShell showed slight increase of the average nanoparticle size of model liposomal template formulation, as shown in FIG. 7, indicating that adsorption of successive biopolymer layers (up to 8 alternating layer) onto template formulation does not significantly increase the average particle size or stability of the agricultural formulation. No significant differences were also observed by exchanging the type of biopolymer used for fabrication of AgriShell; (i) CHT: chitosan+ALG: alginate vs (ii) CHT: chitosan+DXS: dextran.

In addition to particle size analysis, surface tension analysis of the liposomal coated formulations (FIG. 8) showed an increase in surface tension angle as the number of biopolymer layers increase around the coated liposome core, which an important property for promoting environmental stability and reducing liposome absorption to a target plant. Additionally, the selected biopolymer layer seems to affect the shape of the surface tension cone, supporting the tailoring properties of AgriShell technologies as shown in FIG. 8.

Finally, the effect of the number of AgriShell layers on release profiles of model agricultural active ingredient loaded into the liposomal core formulation is shown in FIG. 9. Results indicate the number of biopolymer coating layers directly impact the release profile of the active ingredient encapsulated into the liposomal formulation, suggesting AgriShell can efficiently modulate the desired release profiles through selecting the optimal number of coating layers around the template core. The higher number of layers (4 pairs of two biopolymers: CHT+ALG or CHT+DXS) showed the highest efficacy for controlled release, retaining more of the active into the encapsulating system and showing a significant improvement for reducing burst release stage when compared to the un-coated liposomal system. Results also showed no significant differences between different biopolymer (either ALG or DXS in pair with CHT) used as coating agent in AgriShell.

### Example 2. Use of AgriShell Technology for Stabilization and Controlled Release of Agricultural Active Ingredients Loaded into Minicell Core Formulation

To assess effect of AgriShell on stabilization and controlled release of agricultural active ingredients, biopesticide agent eugenol was encapsulated into a bacterial minicell core template and its surface was coated by AgriShell technology. Eugenol was selected as model postharvest biocide for controlled release experiments. Eugenol-loaded minicell core formulations (with and without biopolymer coating) were prepared in PBS (1×, pH 7.4) and diluted to a known concentration of biocide in release media. Two release media were considered for release experiments; (i) one release media composed of aqueous ethanol (10% v/v) and (ii) the second release media composed of Tween 80 emulsifier in tap water (0.25% v/v), to illustrate the effect of stabilizing agent on the final properties of AgriShell technology. 1 mL of eugenol-loaded minicell samples in each release media were added into 1 mL centrifuge tubes and kept under continuous stirring. At previously determined time-points (2, 4, 8, 12 and 24 hours) samples were centrifuged at 12,000 rpm for 5 minutes and aliquots of 1 mL of supernatant were taken from release media and replaced by same volume of fresh media. Samples collected from release media at the determined time points were tested for Eugenol content by UV-vis spectrometry at 280 nm using ethanol (100% v/v) as dilution media. Eugenol released from each sample (eugenol; minicell-loaded eugenol (MC-Eug); minicell-encapsulated eugenol with CHT 0.1% (MC-Eug CHT 0.1%); minicell-loaded eugenol with CHT 0.1% (MC-Eug CHT 0.1%)) was measured to obtain percentage cumulative release over the selected timeframe in each sample. Original content of Eugenol loaded into minicell (MC-Eug) and contents of Eugenol loaded into minicell with CHT for surface coating (MC-Eug CHT 0.1% and MC-Eug CHT 1%) were quantified by solvent extraction with ethanol (100% v/v) directly from the minicells after being released.

### Experimental Results

Release profiles for model biocide Eugenol from minicell platform are shown in FIG. 10A-10B. Results indicate minicell platform efficiently prevents immediate release of Eugenol into release media, showing percentage release profile consistent with the behavior of a controlled release system, with no burst release at initial time-points (at 2 hours) and reaching a sustained release profile between 12 to 24 hours for both release medium and about 90% and 100% released in ethanol 10% v/v and Tween 80 0.25% v/v, respectively, under the selected experimental conditions. Effect of chitosan coating of minicell loaded with Eugenol on controlled release showed a dependance on chitosan concentration. Efficacy of chitosan coating for improving Eugenol release profiles from minicell platform seemed to be more effective in release media composed by Tween 80 0.25% v/v. Chitosan-coated minicell encapsulating eugenol showed about 10% improvement (i.e. delayed release) of controlled release profiles in chitosan coating at 0.1% w/v and about 20% (i.e. delayed release) for chitosan coating at 1.0% w/v, when compared to chitosan-uncoated minicell encapsulation eugenol (FIG. 10B). Results for chitosan coating in EtOH 10% v/v release media showed no apparent differences in improved controlled release profiles for Eugenol from chitosan-uncoated minicell or chitosan-coated minicell (CHT 0.1% w/v) and about 10% improvement in the release profile for chitosan-coated minicell (CHT 1.0% w/v), suggesting ethanol may play a negative role in stability of chitosan-coated minicell platform.

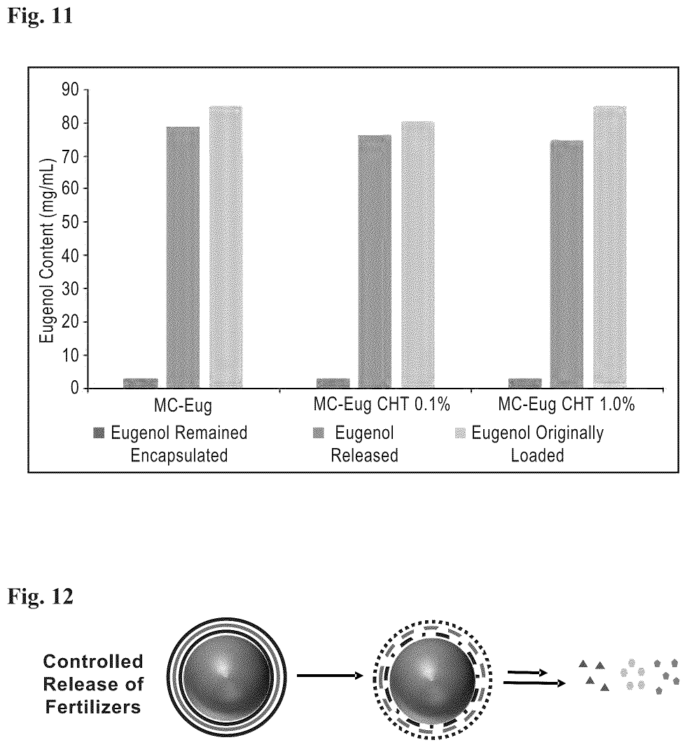

FIG. 11 shows the mass balance for eugenol remained within minicells against eugenol released from minicells with and without chitosan coating, indicating a good recovery of total Eugenol loaded after release studies for 24 hours, under selected experimental conditions.

To examine effect of AgriShell on dynamic release of another agricultural active ingredient (i.e. thyme oil), 100 mg of thyme oil was encapsulated into minicells (MC) and coated with alternating layers of biopolymers. Four samples were prepared for this experiment; (1) MC: minicells were loaded with thyme oil, but not coated with biopolymers, (2) MC-CHT: thyme oil-loaded minicells were coated with chitosan (10 mg/mL), (3) MC-CHT-ALG: thyme oil-loaded minicells were coated with chitosan (CHT 10 mg/mL) as the 1^{st} layer and alginate (AGL 10 mg/mL) as the 2^{nd} layer, (4) MC-CHT-ALG-CHT: thyme oil-loaded minicells were coated with chitosan (CHT 10 mg/mL) as the 1^{st} layer and alginate (AGL 10 mg/mL) as the 2^{nd} layer and chitosan (CHT 10 mg/mL) as the 3^{rd} layer.

Load indicates ethanol extract corresponding to the original concentration of thyme oil in each formulation. Cycle 1 indicates released thyme oil after first cycle of extraction with tap water. Cycle 2 indicates released thyme oil after second cycle of extraction with tap water. Extract indicates released thyme oil after extraction cycle with ethanol. Total indicates mass balance comparing original thyme oil content and total thyme oil released (cycle 1+cycle 2+extract).

Results in FIG. 16 show the positive effect of increased number of biopolymer multilayers on improving the release profiles of thyme oil encapsulated into minicells. The minicell formulation containing no biopolymer coating showed the higher released of thyme oil in the first cycle and the lower retention of thyme oil in the final ethanol extract, whereas the formulation containing the higher number of biopolymer layers (i.e. 3 layers) showed the lower initial release of thyme oil in cycle 1 and retained the higher amount of thyme oil in the final ethanol extract. Biopolymer coated formulations showed a multilayer dependent trend for both reduction of initial burst release and increase in encapsulated thyme oil after two cycles of dynamic release in tap water.

To examine effects of biopolymer coating on preventing volatilization of active ingredient (thyme oil) encapsulated into minicells in a thermal setting with high temperature (40° C. for 2 hours), 100 mg of thyme oil was encapsulated into minicells (MC) and coated with alternating layers of biopolymers. Four samples were prepared for this experiment, as used in FIG. 16; (1) MC, (2) MC-CHT, (3) MC-CHT-ALG, and (4) MC-CHT-ALG-CHT.

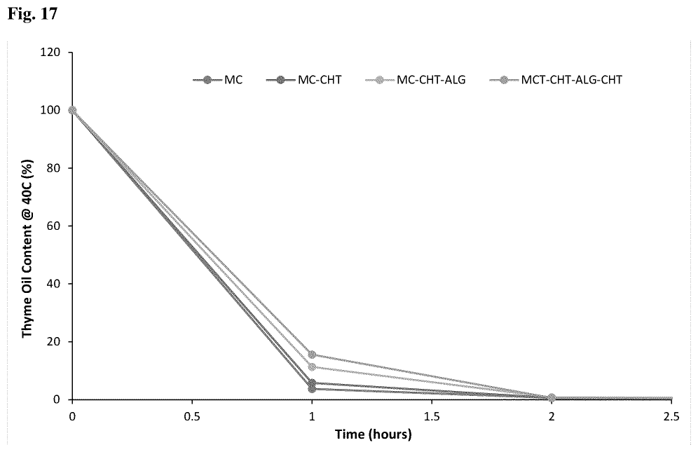

Application of thyme oil as biopesticide is limited due to its known high volatility that depicts in reduction of efficacy in the field, when applied in locations showing high temperatures. Thyme oil was encapsulated into minicells and the formulation was further coated with alternating biopolymer layer of chitosan (CHT, 10 mg/mL) and alginate (ALG, 10 mg/mL). Concentrated samples were dilute 10× in tap water and applied onto glass microscope slides (200 uL) that were placed in an incubator at 40° C. and remaining concentration of thyme oil was determined after 1 hour and 2 hours of temperature exposure. FIG. 17 shows effects of biopolymer coating on preventing volatilization of active ingredient (thyme oil) encapsulated into minicells in a high temperature setting. Results suggest biopolymer multilayers can prevent thyme oil volatilization in about 4-fold, when compared to thyme oil encapsulated into minicells with no biopolymer coating, after incubation of 40° C. for 1 hour.

### Example 3. Use of AgriShell Technology for Stabilization and Controlled Release of Agricultural Fertilizers

AgriShell technology can act as a functional coating for protecting different solid and liquid agricultural fertilizing formulations, such as solid microparticles (NPK, urea and carbamide, among others), liquid formulations (NPK, urea, fermentation broths and microorganism suspensions, among others). The selected formulation acts as a core template or as loading solution and the AgriShell acts as surface nanocoating or entrapping microcapsule shell, allowing casting of as many coating layers as required, via layer-by-layer self-assembly, to provide the desired performance, such as environmental stability (UV radiation, heat, humidity) and/or long term-controlled release, as shown in FIG. 12.

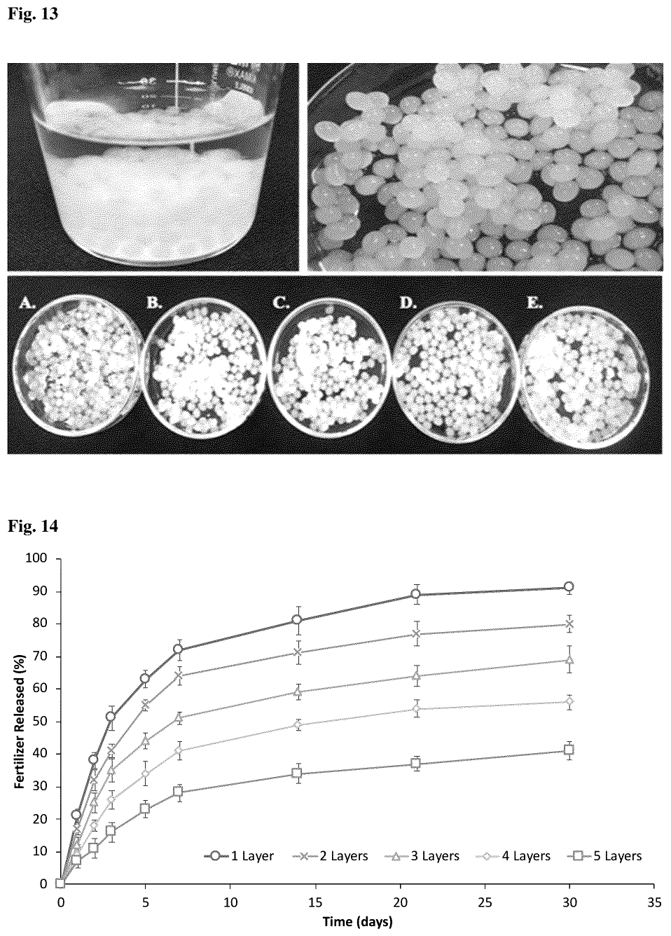

AgriShell technology was applied to microencapsulation of liquid fertilizer formulations. Fertilizing solutions were mixed with AgriShell biopolymer solution and the first biopolymer layer was created by addition of stabilizing agent solution and promoting entrapment of fertilizer in its aqueous core. The loaded AgriShell microparticles were left overnight for hardening in the stabilizing solution followed by layer-by-layer self-assembly of alternating biopolymers layers up to 5× biopolymer layers around the base AgriShell layer, the physical appearance of the formulated AgriShells is shown in FIG. 13.

FIG. 14 shows the effect of alternating biopolymer layers on AgriShell on the release profiles of loaded fertilizer solutions. Results were consistent with previous observations in Examples 1-3, indicating the number of biopolymer layers on AgriShell can effectively modulate the release profile of loaded active fertilizers, with the higher number of coating layers providing the most delayed release of entrapped fertilizer as a function of time.

### Example 4. Use of AgriShell Technology as Protective Functional Coating for Agricultural Products and Seeds

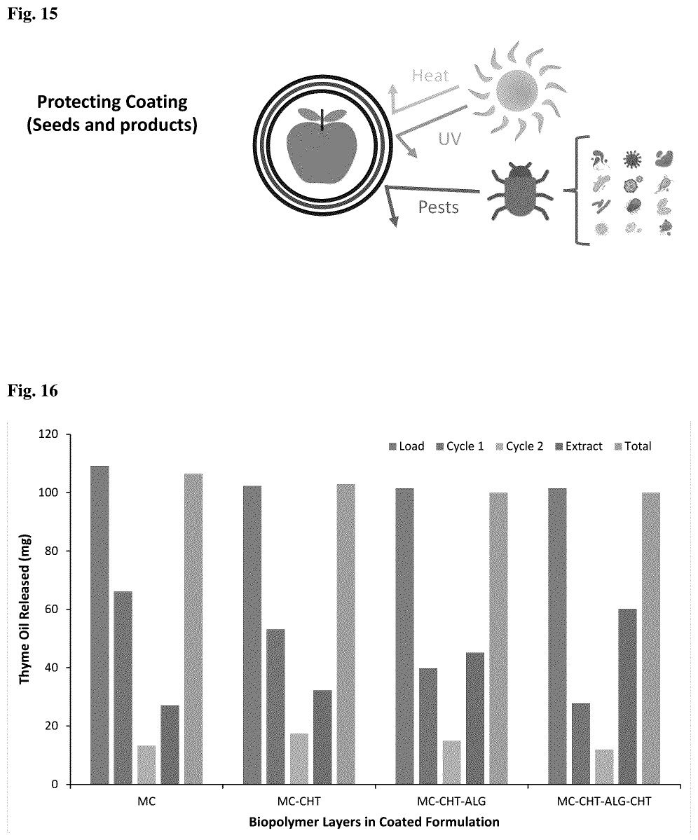

AgriShell technology can act as a functional coating for protecting different agricultural products (plants, fruits, vegetables or seeds, among others). The selected formulation acts as a core template and the AgriShell acts as surface nanocoating, allowing casting of as many coating layers as required, via layer-by-layer self-assembly, to provide the desired performance, such as environmental stability (UV radiation, heat, humidity) and/or protection from pests, such as insects, fungus and pathogen microorganisms, among others, as shown in FIG. 15.

### Example 5. Antifungal Properties of AgriShell Formulations Incorporating Essential Oils

### (1) Evaluation of Fungicides for Postharvest Control of Black Rot in Sweet Potato

To evaluate effects of AgrilShell formulations comprising fungicides for postharvest control of black rot in sweet potato, this experiment was conducted at the Central Crops Research Station. Sweet potato roots used in the study were grown and rinsed in water prior to use. Roots were previously cured and were selected based upon similar size, shape, and disease-free appearance. A spore suspension was created by dislodging ascospores from cultures of Ceratocystis fimbriata isolate AS186 grown on 100-mm agar plates and adding them to 190 L of water. The approximate concentration of the spore suspension was 1.0×103 spores/ml. Sweet potatoes were placed into a 379-L bin containing the spore suspension. The spore suspension, along with the roots, were gently agitated for 20 min to ensure a homogenous solution throughout the inoculation. Following inoculation, roots were taken out of the spore suspension and allowed to air dry. Roots were then placed onto a packing line and fungicide spray treatments were applied using a compressed air pressurized sprayer delivering 0.5 gal/2,000 lb of roots at 20 psi with four TG-1 full cone nozzles. Enough product was used to ensure complete coverage of each sweet potato. After fungicide application, sweet potatoes were placed into clear, plastic containers (40×50×17.9 cm) and stored at 24° C. and 99% relative humidity for 28 days. Roots used for the non-treated control were inoculated, but had no treatments applied. Ten replications per treatment were included with 5 roots per replication. Roots were rated for disease incidence (number of lesions on each root per box) at 7, 14, 21, and 28 days after inoculation. Disease severity (percent area covered in lesions) was rated at 7, 14, 21, and 28 days after inoculation. Data were analyzed in the software ARM (Gylling Data Management, Brookings, SD) using analysis of variance (AOV) and Fisher's Protected LSD test (P=0.05) to separate means.

In this trial, the essential oil, thyme oil, was used as a fungicide. For this experiment, AGR-Biofunl (3% v/v) corresponds to thyme oil encapsulated into minicells (without biopolymer layer coated) and AGR-Biofun2 (6% v/v) corresponds to biopolymer-coated minicells (AgriShell) encapsulating thyme oil. Mertect® 340F (commercial fungicide) was used as a positive control to show fungicidal effect from an exemplary commercial synthetic fungicide.

Black rot was first observed at 7 days after inoculation. Roots treated with Mertect® 340F (commercial fungicide) had the lowest incidence and severity at each rating date. Both AGR-Biofun 1 and AGR-Biofun2 showed significantly lower incidence at all dates when compared to the nontreated control. AGR-Biofun1, AGR-Biofun2, and Mertect® 340F showed significantly lower severity than the nontreated control 14 days after treatment (Table 2). AGR-Biofun2 and Mertect® 340F both showed significantly lower severity that the nontreated 7 days after treatment. No phytotoxicity was observed in any treatment.

TABLE 2
Experimental Results for fungicides for postharvest control of black rot in sweet potato

| | Disease Incidence^{z} | | | | Disease Severity^{y} | | | |
|---|---|---|---|---|---|---|---|---|
| Days after Treatment | 28 days | 21 days | 14 days | 7 days | 28 days | 21 days | 14 days | 7 days |
| Nontreated | 7.28 a^{x} | 6.36 a | 6.50 a | 1.30 a | 7.68 a | 3.32 a | 3.64 a | 0.78 a |
| AGR-Biofun1—3% V/V | 5.78 b | 5.18 b | 4.40 b | 0.76 b | 6.42 ab | 1.78 a | 2.52 b | 0.58 ab |
| AGR-Biofun2—6% V/V | 5.46 b | 4.80 b | 3.04 c | 0.78 b | 6.68 a | 2.06 a | 2.00 bc | 0.46 b |
| Mertect 340F—0.42 fl/ton | 3.12 c | 2.80 c | 2.06 c | 0.70 b | 4.38 b | 1.26 a | 1.30 c | 0.54 b |

^{z}Disease incidence was calculated by the number of lesions on each sweet potato.
^{y}Disease severity was calculated by the percentage of each sweet potato covered by black rot lesions
^{x}Treatments followed by the same letter(s) within a column are not statistically different (P = 0.05, Fisher's Protected LSD).

As presented in Table 2, AGR-Biofun2 (with AgriShell) showed improvement in efficacy, statistically significant for day 21 for disease incidence and after day 21 for disease severity when compared to AGR-Biofun 1 (without AgriShell). The improved performance could be obtained from a combination of increased stability, controlled release, and plant targeting of AGR-Biofun2 with AgriShell in comparison to AGR-Biofun1 without AgriShell.

### (2) Evaluation of Fungicides for Postharvest Management of Rhizopus Soft Rot in Sweet Potato

To evaluate effects of AgriShell formulations comprising fungicides for postharvest management of Rhizopus soft rot in sweet potato, this experiment was conducted at the Central Crops Research Station. Sweet potato roots used in the study were grown and rinsed in water prior to use. Roots were previously cured and were selected based upon similar size, shape, and disease-free appearance. Sweet potatoes were wounded using a calibrated, rubber-band-propelled wooden dowel. After wounding, roots were inoculated with a spore suspension applied with a repeating micropipette. The approximate concentration of the spore suspension was 1.0×10⁶ spores/mL. Following inoculation, roots were taken out of the spore suspension and allowed to air dry. Roots were then placed onto a packing line and fungicide spray treatments were applied using a compressed air pressurized sprayer delivering 0.5 gal/2,000 lb of roots at 20 psi with four TG-1 full cone nozzles. Enough product was used to ensure complete coverage of each sweet potato. After fungicide application, sweet potatoes were placed into clear, plastic containers (40×50×17.9 cm) and stored at 27° C. and 99% relative humidity for 14 days. Roots used for the non-treated control were inoculated, but had no treatments applied. Ten replications per treatment were included with 5 roots per replication. Roots were rated for disease incidence (percentage of wounds infected) at 3, 7, 10, and 14 days after inoculation. Disease severity (percent of root infected/soft) was rated at 3, 7, 10, and 14 days after inoculation. Data were analyzed in the software ARM (Gylling Data Management, Brookings, SD) using analysis of variance (AOV) and Fisher's Protected LSD test (P=0.05) to separate means.

In this trial, the essential oil, thyme oil, was used as a fungicide. For this experiment, AGR-Biofun1 (3% v/v) corresponds to thyme oil encapsulated into minicells (without biopolymer layer coated) and AGR-Biofun2 (6% v/v) corresponds to biopolymer-coated minicells (AgriShell) encapsulating thyme oil. Stadium® (commercial fungicide) was used as a positive control to show fungicidal effect from an exemplary commercial synthetic fungicide.

Rhizopus was first observed at 3 days after inoculation. Stadium provided a significant reduction in disease severity on 17, 10, and 14 days after inoculation. AGR-Biofun2 showed significantly lower severity that the nontreated and AGR-Biofun1 treatments. No significant differences were observed between any treatments in disease incidence at any rating date. No phytotoxicity was observed in any treatment.

TABLE 3
Experimental Results for fungicides for postharvest management of Rhizopus soft rot in sweet potato

| | Disease Severity (%)^{z} | | | | Disease Incidence (%)^{y} | | | |
|---|---|---|---|---|---|---|---|---|
| Days after Treatment | 14 days | 10 days | 7 days | 3 days | 14 days | 10 days | 7 days | 3 days |
| AGR-Biofun1—3% V/V | 49.3 a^{x} | 45.2 a | 41.6 a | 6.2 a | 100.0 a | 100.0 a | 98.0 a | 86.0 a |
| Nontreated | 47.0 a | 43.5 a | 39.72 a | 7.3 a | 94.0 a | 94.0 a | 92.0 a | 80.0 a |
| AGR-Biofun2—6% V/V | 31.1 ab | 28.2 ab | 24.5 ab | 6.0 a | 94.0 a | 94.0 a | 90.0 a | 84.0 a |
| Stadium—1 fl oz/ton | 21.6 b | 19.0 b | 15.2 b | 3.5 a | 92.0 a | 84.0 a | 76.0 a | 66.0 a |

^{z}Disease Severity was calculated by the percentage of each sweet potato in the box that was soft/infected
^{y}Disease incidence was calculated for each treatment based on the percentage of sweet potatoes per box infected.
^{x}Treatments followed by the same letter(s) within a column are not statistically different (P = 0.05, Fisher's Protected LSD).

Similar to black rot control experiment above, AGR-Biofun2 (with AgriShell) showed to be statistically more effective than AGR-Biofun1 (without AgriShell) after day 7 for disease severity as presented in Table 3. The improved performance could be obtained from a combination of increased stability, controlled release, and plant targeting of AGR-Biofun2 with AgriShell in comparison to AGR-Biofun1 without AgriShell.

### (3) Evaluation of Fungicide Efficacy Against Powdery Mildew on Sweetened Hemp Cultivar

Greenhouse experiments were conducted. Plants were inoculated with powdery mildew and treated post-inoculation with the different biofungicide formulations at the proposed dilution application. Treatments were applied weekly for a total of three applications. Fungicide efficacy was reported in terms of incidence (%), severity (%) and disease index. Water was used as negative control and Luna Exp. (Fluopyram and Tebuconazole) was used as positive control. The essential oil used in this trial was thyme oil. For this trial, AGS 1 corresponds to thyme oil encapsulated into minicells (without biopolymer layer coated) and AGS 2 corresponds to biopolymer coated minicells (AgriShell) encapsulating thyme oil.

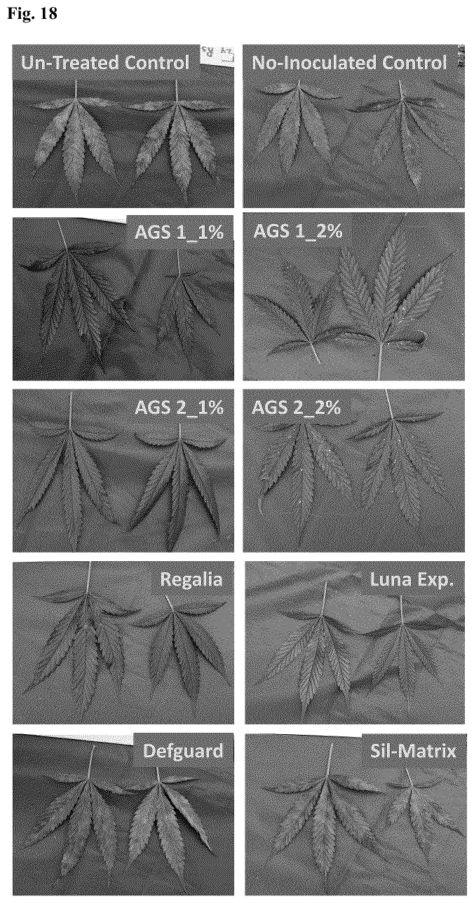

All treatments demonstrated efficacy in terms of disease index, when compared to control treatment (water). AGS 2 (biopolymer coated minicells) treatments showed the highest levels of efficacy with statistical differences in terms of incidence of disease and severity, when compared to AGS 1 (without biopolymer coated). AGS 2 also showed statistically significant differences on overall disease index DI_AUDPC (area under the disease progress curve) and showing performance like the highest standard synthetic treatments such as Regalia and Luna Experience. FIG. 18. Presents fungicide efficacy of (i) minicells encapsulated thyme oil (AGS 1) and (ii) biopolymer coated minicells-thyme oil (AGS 2) against powdery mildew on sweetened hemp cultivar in the greenhouse.

TABLE 4
Experimental Results for fungicide efficacy against powdery mildew on sweetened hemp cultivar:
Fungicide efficacy against powdery mildew on sweetened hemp cultivar in the greenhouse

TRT

| (Appl. | | | | | | | | | | | | | | | | | | | | | |
|---|---|---|---|---|---|---|---|---|---|---|---|---|---|---|---|---|---|---|---|---|---|
| rate per | Incidence (%) | | | | | | | Severity (%) | | | | | | | Disease index x | | | | | | |
| 100 mL) | 3/16 | 3/23 | | 3/30 | | I_AUDPC y | | 3/16 | 3/23 | | 3/30 | | S_AUDPC | | 3/16 | 3/23 | | 3/30 | | DI_AUDPC | |
| AGS | 0 | 24 | cdef | 9 | f | 197 | def | 0 | 2 | fg | 3 | fgh | 28 | f | 0 | 0 | d | 1 | d | 2 | d |
| 1_1% | | | | | | | | | | | | | | | | | | | | | |
| AGS | 0 | 1 | f | 33 | bcdef | 117 | def | 0 | 0 | g | 9 | defgh | 34 | ef | 0 | 0 | d | 5 | cd | 19 | cd |
| 1_2% | | | | | | | | | | | | | | | | | | | | | |
| AGS | 0 | 0 | f | 1 | f | 2 | f | 0 | 0 | g | 1 | h | 2 | f | 0 | 0 | d | 0 | d | 0 | d |
| 2_1% | | | | | | | | | | | | | | | | | | | | | |
| AGS | 0 | 4 | ef | 11 | f | 63 | ef | 0 | 0 | g | 5 | efgh | 19 | f | 0 | 0 | d | 1 | d | 2 | d |
| 2_2% | | | | | | | | | | | | | | | | | | | | | |
| Regalia | 0 | 0 | f | 12 | f | 42 | ef | 0 | 0 | g | 3 | fgh | 12 | f | 0 | 0 | d | 1 | d | 3 | d |
| Luna | 0 | 0 | f | 0 | f | 0 | f | 0 | 0 | g | 0 | h | 0 | f | 0 | 0 | d | 0 | d | 0 | d |
| Experience | | | | | | | | | | | | | | | | | | | | | |
| Stargus | 0 | 40 | abcde | 54 | abcd | 469 | abcd | 0 | 7 | cdef | 17 | cde | 107 | bcd | 0 | 3 | bcd | 11 | cd | 37 | cd |
| Exile | 0 | 21 | def | 28 | cdef | 248 | cdef | 0 | 3 | efg | 7 | defgh | 45 | ef | 0 | 1 | d | 2 | d | 7 | d |
| Defguard | 0 | 70 | a | 66 | ab | 722 | a | 0 | 13 | ab | 23 | c | 168 | b | 0 | 9 | a | 16 | bc | 57 | bc |
| Cinerrate | 0 | 35 | abcdef | 21 | def | 320 | bcdef | 0 | 3 | efg | 6 | defgh | 43 | ef | 0 | 1 | cd | 2 | d | 6 | d |
| Sil-matrix | 0 | 30 | bcdef | 51 | abcde | 390 | abcde | 0 | 3 | efg | 10 | cdefgh | 55 | def | 0 | 2 | cd | 7 | cd | 23 | cd |
| Untreated | 0 | 66 | ab | 80 | a | 744 | a | 0 | 11 | bc | 54 | a | 265 | a | 0 | 7 | ab | 43 | a | 152 | a |
| control | | | | | | | | | | | | | | | | | | | | | |
| Non- | 0 | 63 | abc | 75 | a | 700 | a | 0 | 15 | a | 37 | b | 234 | a | 0 | 9 | a | 28 | b | 99 | b |
| treated | | | | | | | | | | | | | | | | | | | | | |
| Non- | | | | | | | | | | | | | | | | | | | | | |
| inoculated | | | | | | | | | | | | | | | | | | | | | |

x Disease index (DI) = (I * S)/100, where DI = disease index, I = disease incidence, S = disease severity, and 100 represents the maximum possible incidence and severity scores.
y AUDPC (Area Under the Disease Progress Curve) = sum (((average (rating on 9 Mar. + rating on 16 Mar.)) * (days between 9 Mar. and 16 Mar.) + average (rating 16 Mar. + rating on 23 Mar.)) * (days between 23 Mar. and 16 Mar.) + (average (rating on 23 Mar. + rating on 30 Mar.)) * (days between 30 Mar. and 23 Mar.)). AUDPC is the intensity of disease parameter across given dates.
z Means followed by the same letter(s) within columns are not significantly different (Tukey test, P < 0.05).

### NUMBERED EMBODIMENTS OF THE DISCLOSURE

Notwithstanding the appended claims, the disclosure sets forth the following numbered embodiments:

### A Coating Platform for Agricultural Use

1. A coating platform for agricultural use, comprising a layer-by-layer assembly, wherein the layer-by-layer assembly comprises at least two biopolymers, wherein said two biopolymers are selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof,
wherein said biopolymers are assembled by a noncovalent bond,
wherein one selected biopolymer can form said layer-by-layer assembly comprising the selected biopolymer by said noncovalent bond, and
wherein said platform comprises an agricultural agent within the platform.
2. The coating platform of embodiment 1, wherein said platform is stabilized by an addition of a stabilizing agent.
3. The coating platform of embodiment 1 or 2, wherein a first biopolymer is chitosan.
4. The coating platform of embodiment 1 or 2, wherein a second biopolymer is alginate, dextran sulfate, or sulfonated lignin.
5. The coating platform of embodiment 1, wherein said at least two biopolymers comprise chitosan and alginate.
6. The coating platform of embodiment 1, wherein said at least two biopolymers comprise chitosan and dextran sulfate.
7. The coating platform of embodiment 2, wherein said stabilizing agent is selected from a pH regulator, a non-ionic surfactant and a crosslinker agent.
8. The coating platform of embodiment 7, wherein said pH regulator is selected from Phosphate buffer saline (PBS), ammonium buffer, acetate buffer, citrate buffer, and carbonate buffer.
9. The coating platform of embodiment 7, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.
10. The coating platform of embodiment 7, wherein said crosslinker agent is selected from Genipin, calcium chloride, tripolyphosphate, proanthocyanidins, epigallocatechin gallate, and glucosaminoglycans.
11. The coating platform of embodiment 1, wherein said agricultural agent is an agrochemical, a biologically active agent, or an agricultural product.
12. The coating platform of embodiment 11, wherein said agrochemical or said biologically active agent is loaded into a microparticle.
13. The coating platform of embodiment 12, wherein said microparticle comprises a minicell or a colloidal carrier.
14. The coating platform of embodiment 13, wherein said colloidal carrier is selected from a liposome, a noisome, a microsphere, a nanosphere, and an emulsion.
15. The coating platform of embodiment 11, wherein said agricultural product is selected from a seed, a grain, a fruit, a seedling, a leafy vegetable, a fresh-cut plant produce, and an edible part of a plant.
16. The coating platform of embodiment 1, wherein said layer-by-layer assembly comprises at least 3, 4, 5, 6, or more layers.
17. The coating platform of any one of embodiments 1-16, wherein said coating platform forms a macromolecular structure.
18. The coating platform of embodiment 17, wherein said macromolecular structure is a thin film, a nanoparticle, a molecular aggregate, a colloidal suspension, or a microcapsule.
19. The coating platform of any one of embodiments 1-18, wherein the platform is in the form of an emulsion, a film, a spray coating, a dip coating, a dissolution, or a combination thereof.
20. The coating platform of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### A Coating Platform for Agricultural Use

1. A coating platform for agricultural use, comprising a layer-by-layer assembly, wherein the layer-by-layer assembly comprises at least two polymers,
wherein a first polymer comprises a cationic polymer and a second polymer comprises an anionic polymer,
wherein said first and second polymers are assembled by a noncovalent bond,
wherein said layer-by-layer assembly is formed by alternating layers of at least one cationic polymer and at least one anionic polymer, and
wherein said platform comprises an agricultural agent within the platform.
2. The coating platform of embodiment 1, wherein said platform is stabilized by an addition of a stabilizing agent.
3. The coating platform of embodiment 1, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).
4. The coating platform of embodiment 1, wherein said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate.
5. The coating platform of embodiment 3, wherein said cationic polymer is chitosan.
6. The coating platform of embodiment 4, wherein said anionic polymer is alginate, dextran sulfate, or sulfonated lignin.
7. The coating platform of embodiment 2, wherein said stabilizing agent is selected from a pH regulator, a non-ionic surfactant and a crosslinker agent.
8. The coating platform of embodiment 7, wherein said pH regulator is selected from Phosphate buffer saline (PBS), ammonium buffer, acetate buffer, citrate buffer, and carbonate buffer.
9. The coating platform of embodiment 7, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.
10. The coating platform of embodiment 7, wherein said crosslinker agent is selected from Genipin, calcium chloride, tripolyphosphate, proanthocyanidins, epigallocatechin gallate, and glucosaminoglycans.
11. The coating platform of embodiment 1, wherein said agricultural agent is an agrochemical, a biologically active agent, or an agricultural product.
12. The coating platform of embodiment 11, wherein said agrochemical or said biologically active agent is loaded into a microparticle.
13. The coating platform of embodiment 12, wherein said microparticle comprises a minicell or a colloidal carrier.
14. The coating platform of embodiment 13, wherein said colloidal carrier is selected from a liposome, a noisome, a microsphere, a nanosphere, and an emulsion.
15. The coating platform of embodiment 11, wherein said agricultural product is selected from a seed, a grain, a fruit, a seedling, a leafy vegetable, a fresh-cut plant produce, and an edible part of a plant.
16. The coating platform of embodiment 1, wherein said layer-by-layer assembly comprises at least 3, 4, 5, 6, or more layers.
17. The coating platform of any one of embodiments 1-16, wherein said coating platform forms a macromolecular structure.
18. The coating platform of embodiment 17, wherein said macromolecular structure is a thin film, a nanoparticle, a molecular aggregate, a colloidal suspension, or a microcapsule.
19. The coating platform of any one of embodiments 1-18, wherein the platform is in the form of an emulsion, a film, a spray coating, a dip coating, a dissolution, or a combination thereof.
20. The coating platform of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### A Multilayered Biopolymer Composition for Agricultural Use

1. A multilayered biopolymer composition for agricultural use, comprising:
   a. a first biopolymer which is chitosan,
   b. a second biopolymer which is alginate, dextran sulfate, or sulfonated lignin,
wherein said two biopolymers are assembled by a noncovalent bond, and
wherein said composition comprises an agricultural agent within the composition.
2. The multilayered biopolymer composition of embodiment 1, wherein said molecule is stabilized by an addition of a stabilizing agent.
3. The multilayered biopolymer composition of embodiment 2, wherein said stabilizing agent is selected from a pH regulator, a non-ionic surfactant and a crosslinker agent.
4. The multilayered biopolymer composition of embodiment 3, wherein said pH regulator is selected from Phosphate buffer saline (PBS), ammonium buffer, acetate buffer, citrate buffer, and carbonate buffer.
5. The multilayered biopolymer composition of embodiment 3, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and tween®.
6. The multilayered biopolymer composition of embodiment 3, wherein said crosslinker agent is selected from Genipin, calcium chloride, tripolyphosphate, proanthocyanidins, epigallocatechin gallate, and glucosaminoglycans.
7. The multilayered biopolymer composition of embodiment 1, wherein said agricultural agent is an agrochemical, a biologically active agent, or an agricultural product.
8. The multilayered biopolymer composition of embodiment 7, wherein said agrochemical or said biologically active agent is loaded into a microparticle.
9. The multilayered biopolymer composition of embodiment 8, wherein said microparticle comprises a minicell or a colloidal carrier.
10. The multilayered biopolymer composition of embodiment 9, wherein said colloidal carrier is selected from a liposome, a noisome, a microsphere, a nanosphere, and an emulsion.
11. The multilayered biopolymer composition of embodiment 7, wherein said agricultural product is selected from a seed, a grain, a fruit, a seedling, a leafy vegetable, a fresh-cut plant produce, and an edible part of a plant.
12. The multilayered biopolymer composition of embodiment 1, wherein said multilayered biopolymer molecule comprises at least 2, 3, 4, 5, 6, or more layers.
13. The multilayered biopolymer composition of any one of embodiments 1-12, wherein said coating platform forms a macromolecular structure.
14. The multilayered biopolymer composition of embodiment 13, wherein said macromolecular structure is a thin film, a nanoparticle, a molecular aggregate, a colloidal suspension, or a microcapsule.
15. The multilayered biopolymer composition of any one of embodiments 1-14, wherein the composition is in the form of an emulsion, a film, a spray coating, a dip coating, a dissolution, or a combination thereof.
16. The multilayered biopolymer composition of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### A Composition Comprising an Agricultural Agent and a Layer-by-Layer Assembly

1. A composition comprising an agricultural agent coated by a layer-by-layer assembly comprising at least two biopolymers.
2. The composition of embodiment 1, wherein said two biopolymers are selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof.
3. The composition of embodiment 1, wherein said biopolymer-coated agricultural agent is generated by a process comprising use of said layer-by-layer assembly of said at least two biopolymers onto said agricultural agent.
4. The composition of embodiment 2, wherein said at least two biopolymers comprise chitosan and alginate.
5. The composition of embodiment 2, wherein said at least two biopolymers comprise chitosan and dextran sulfate.
6. The composition of any one of embodiments 1-3, wherein said layer-by-layer assembly is formed by noncovalent bond.
7. The composition of embodiment 1, wherein said agricultural agent is an agrochemical, a biologically active agent, or an agricultural product.
8. The composition of embodiment 7, wherein said agrochemical or said biologically active agent is loaded into a microparticle.
9. The composition of embodiment 8, wherein said microparticle comprises a minicell or a colloidal carrier.
10. The composition of embodiment 9, wherein said colloidal carrier is selected from a liposome, a noisome, a microsphere, a nanosphere, and an emulsion.
11. The composition of embodiment 7, wherein said agricultural product is selected from a seed, a grain, a fruit, a seedling, a leafy vegetable, a fresh-cut plant produce, and an edible part of a plant.
12. The composition of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### Method of Preparing a Multilayered Polymer Composition

1. A method of preparing a multilayered polymer composition for encapsulation and delivery of an agricultural agent, said method comprising the steps of:
   a) providing a pair of polymers, wherein a first polymer comprises a cationic polymer and a second polymer comprises an anionic polymer;
   b) allowing layer-by-layer assembly of said first polymer and said second polymer;
   c) optionally, adding a stabilizing agent to said layer-by-layer assembly; and
   d) coating the agricultural agent with said layer-by-layer assembly;
wherein said two polymers are assembled by a noncovalent bond.
2. The method of embodiment 1, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).
3. The method of embodiment 1, wherein said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate.
4. The method of embodiment 2, wherein said cationic polymer comprise chitosan.
5. The method of embodiment 3, wherein said anionic polymer comprise alginate, dextran sulfate, or sulfonated lignin.
6. The method of embodiment 1, wherein said stabilizing agent is selected from a pH regulator, a non-ionic surfactant and a crosslinker agent.
7. The method of embodiment 6, wherein said pH regulator is selected from Phosphate buffer saline (PBS), ammonium buffer, acetate buffer, citrate buffer, and carbonate buffer.
8. The method of embodiment 6, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.
9. The method of embodiment 6, wherein said crosslinker agent is selected from Genipin, calcium chloride, tripolyphosphate, pro anthocy anidin s , epigallocatechin gallate, and glucosaminoglycans.
10. The method of embodiment 1, wherein said agricultural agent is an agrochemical, a biologically active agent, or an agricultural product.
11. The method of embodiment 10, wherein said agrochemical or said biologically active agent is loaded into a microparticle.
12. The method of embodiment 11, wherein said microparticle comprises a minicell or a colloidal carrier.
13. The method of embodiment 12, wherein said colloidal carrier is selected from a liposome, a noisome, a microsphere, a nanosphere, and an emulsion.
14. The method of embodiment 10, wherein said agricultural product is selected from a seed, a grain, a fruit, a seedling, a leafy vegetable, a fresh-cut plant produce, and an edible part of a plant.
15. The method of embodiment 1, wherein said multilayered polymer composition comprises at least 2, 3, 4, 5, 6, or more layers.
16. The method of embodiment 1, wherein the coating of the agricultural agent with the layer-by-layer assembly increases stability of the agricultural agent from an environmental hazard.
17. The method of embodiment 1, wherein the coating of the agricultural agent with the layer-by-layer assembly promotes controlled release of the agricultural agent.
18. The method of embodiment 10 or 14, wherein said polymer-coated agricultural agent enhances a shelf-life of the agricultural product.
19. The method of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### A Method of Producing a Polymer-Coated Agricultural Agent

1. A method of producing a polymer-coated agricultural agent, the method comprising the steps of:
   a. providing an agricultural agent;
   b. contacting said agricultural agent with a cationic polymer;
   c. contacting said agricultural agent with an anionic polymer; thereby producing said polymer-coated agricultural agent.
2. The method of embodiment 1, further comprising the step of: d) adding a stabilizing agent to said polymer-coated agricultural agent.
3. The method of embodiment 1, wherein steps b) and c) are repeated to encapsulate said agricultural agent with a multilayer of said polymers.
4. The method of embodiment 1, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).
5. The method of embodiment 1, wherein said anionic polymer is selected from alginate, hyaluronic acid, heparin, heparan sulfate, chondroitin sulfate, dextran sulfate, sulfonated lignin,poly(meth)acrylic acid, oxidized cellulose, carboxymethyl cellulose, polyaspartic acid, polyglutamic acid, polyacrylic acid, alginic acid, and polystyrenesulfonate.
6. The method of embodiment 4, wherein said cationic polymer comprise chitosan.
7. The method of embodiment 5, wherein said anionic polymer comprise alginate, dextran sulfate, or sulfonated lignin.
8. The method of embodiment 2, wherein said stabilizing agent is selected from a pH regulator, a non-ionic surfactant and a crosslinker agent.
9. The method of embodiment 8, wherein said pH regulator is selected from Phosphate buffer saline (PBS), ammonium buffer, acetate buffer, citrate buffer, and carbonate buffer.
10. The method of embodiment 8, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.
11. The method of embodiment 8, wherein said crosslinker agent is selected from Genipin, calcium chloride, tripolyphosphate, pro anthocy anidins, epigallocatechin gallate, and glucosaminoglycans.
12. The method of embodiment 1, wherein said agricultural agent is an agrochemical, a biologically active agent, or an agricultural product.
13. The method of embodiment 12, wherein said agrochemical or said biologically active agent is loaded into a microparticle.
14. The method of embodiment 13, wherein said microparticle comprises a minicell or a colloidal carrier.
15. The method of embodiment 14, wherein said colloidal carrier is selected from a liposome, a noisome, a microsphere, a nanosphere, and an emulsion.
16. The method of embodiment 12, wherein said agricultural product is selected from a seed, a grain, a fruit, a seedling, a leafy vegetable, a fresh-cut plant produce, and an edible part of a plant.
17. The method of embodiment 2, wherein said multilayer comprises at least 2, 3, 4, 5, 6, or more layers.
18. The method of embodiment 1, wherein said polymer-coated agricultural agent has increased stability from an environmental hazard when compared to an agricultural agent not encapsulated by a multilayer of said polymers.
19. The method of embodiment 1, wherein said polymer-coated agricultural agent is released in a controlled manner.
20. The method of embodiment 12 or 16, wherein said polymer-coated agricultural agent enhances a shelf-life of the agricultural product.
21. The method of embodiment 1, wherein said agricultural agent is a pesticidal agent, an insecticidal agent, a herbicidal agent, a fungicidal agent, a virucidal agent, a nematicidal agent, a molluscicidal agent, an antimicrobial agent, an antibacterial agent, an antifungal agent, an antiviral agent, an antiparasitic agent, a fertilizing agent, a repellent agent, a plant growth regulating agent, or a plant-modifying agent.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgment or any form of suggestion that they constitute valid prior art or form part of the common general knowledge in any country in the world.

### REFERENCES

U.S. Patent. No. 3,467,604
U.S. Patent Application No. 2012/0016022
U.S. Patent Application No. 2012/0016022
U.S. Patent Application No. 2016/0174571
International Patent application No. WO 09/013361
International Patent application No. WO2018/201160
International Patent application No. WO2018/201161
International Patent application No. WO2019/060903
International Patent application No. WO2021/133846
Rawtani, D., & Agrawal, Y. K. (2014). Emerging Strategies and Applications of Layer-by-Layer Self-Assembly. Nanobiomedicine, 1, 8.
Ogueri, K. S., Jafari, T., Escobar Ivirico, J. L., Laurencin, C. T. Polymeric biomaterials for scaffold-based bone regenerative engineering. Regen. Eng. Transl. Med. 2019, 5, 128-154.
Reddy, M. S. B.; Ponnamma D.; Choudhary, R.; Sadasivuni, K. K. A. Comparative Review of Natural and Synthetic Biopolymer Composite Scaffolds. Polymers 2021, 13, 1105.
Fernandez-Saiz P, Soler C, Lagaron J M, Ocio M J. Effects of chitosan films on the growth of Listeria monocytogenes, Staphylococcus aureus and Salmonella spp. in laboratory media and in fish soup. Int J Food Microbiol. 2010 Feb 28;137(2-3):287-94
Aston, R., Wimalaratne, M., Brock, A., Lawrie, G., & Grondahl, L. (2015). Interactions between chitosan and alginate dialdehyde biopolymers and their layer-by-layer assemblies. Biomacromolecules, 16, 1807-1817
Wang, L. X., Hou, Y. H., Zhong, X., Hu, J. L., Shi, F. W., & Mi, H. Y. (2019). Preparation and catalytic performance of alginate-based Schiff Base. Carbohydrate Polymers, 208, 42-49.
Bhattarai, N., Gunn, J., Zhang, M., Jan. 31, 2010. Chitosan-based hydrogels for controlled, localized drug delivery. Advanced Drug Delivery Reviews 62 (1), 83-99.
Schatz, C., Lucas, J. M., Viton, C., Domard, A., Pichot, C., Delair, T., Aug. 31, 2004. Formation and properties of positively charged colloids based on polyelectrolyte complexes of biopolymers. Langmuir 20 (18), 7766-7778.
Wu, D., Delair, T., Mar. 30, 2015. Stabilization of chitosan/hyaluronan colloidal polyelectrolyte complexes in physiological conditions. Carbohydrate Polymers 119, 149-158.
Luo, Y., Wang, Q., March 2014. Recent development of chitosan-based polyelectrolyte complexes with natural polysaccharides for drug delivery. International Journal of Biological Macromolecules 64, 353-367.
Fan, W., Yan, W., Xu, Z., Ni, H., Feb. 1, 2012. Formation mechanism of monodisperse, low molecular weight chitosan nanoparticles by ionic gelation technique. Colloids and Surfaces B: Biointerfaces 90, 21-27.
Delair, T., May 2011. Colloidal polyelectrolyte complexes of chitosan and dextran sulfate towards versatile nanocarriers of bioactive molecules. European Journal of Pharmaceutics and Biopharmaceutics 78 (1), 10-18.

What is claimed is:

1. A coating platform for agricultural use, comprising a layer-by-layer assembly, wherein the layer-by-layer assembly comprises at least two biopolymers,
wherein said two biopolymers are selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof,
wherein said biopolymers are assembled by a noncovalent bond,
wherein one selected biopolymer can form said layer-by-layer assembly comprising the selected biopolymer by said noncovalent bond, and
wherein said platform comprises an agricultural agent within the platform.

2. The coating platform of claim 1, wherein said platform is stabilized by an addition of a stabilizing agent.

3. The coating platform of claim 1 or 2, wherein a first biopolymer is chitosan.

4. The coating platform of claim 1 or 2, wherein a second biopolymer is alginate, dextran sulfate, or sulfonated lignin.

5. The coating platform of claim 1, wherein said at least two biopolymers comprise chitosan and alginate.

6. The coating platform of claim 1, wherein said at least two biopolymers comprise chitosan and dextran sulfate.

7. The coating platform of claim 2, wherein said stabilizing agent is selected from a pH regulator, a non-ionic surfactant and a crosslinker agent.

8. The coating platform of claim 7, wherein said pH regulator is selected from Phosphate buffer saline (PBS), ammonium buffer, acetate buffer, citrate buffer, and carbonate buffer.

9. The coating platform of claim 7, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.

10. The coating platform of claim 7, wherein said crosslinker agent is selected from Genipin, calcium chloride, tripolyphosphate, proanthocyanidins, epigallocatechin gallate, and glucosaminoglycans.

11. The coating platform of claim 1, wherein said agricultural agent is an agrochemical, a biologically active agent, or an agricultural product.

12. The coating platform of claim 11, wherein said agrochemical or said biologically active agent is loaded into a microparticle.

13. The coating platform of claim 12, wherein said microparticle comprises a minicell or a colloidal carrier.

14. The coating platform of claim 13, wherein said colloidal carrier is selected from a liposome, a noisome, a microsphere, a nanosphere, and an emulsion.

15. The coating platform of claim 11, wherein said agricultural product is selected from a seed, a grain, a fruit, a seedling, a leafy vegetable, a fresh-cut plant produce, and an edible part of a plant.

16. The coating platform of claim 1, wherein said layer-by-layer assembly comprises at least 3, 4, 5, 6, or more layers.

17. The coating platform of any one of claims 1-16, wherein said coating platform forms a macromolecular structure.

18. The coating platform of claim 17, wherein said macromolecular structure is a thin film, a nanoparticle, a molecular aggregate, a colloidal suspension, or a microcapsule.

19. The coating platform of any one of claims 1-18, wherein the platform is in the form of an emulsion, a film, a spray coating, a dip coating, a dissolution, or a combination thereof.

20. A coating platform for agricultural use, comprising a layer-by-layer assembly, wherein the layer-by-layer assembly comprises at least two polymers,
wherein a first polymer comprises a cationic polymer and a second polymer comprises an anionic polymer,
wherein said first and second polymers are assembled by a noncovalent bond,
wherein said layer-by-layer assembly is formed by alternating layers of at least one cationic polymer and at least one anionic polymer, and
wherein said platform comprises an agricultural agent within the platform.

21. The coating platform of claim 20, wherein said platform is stabilized by an addition of a stabilizing agent.

22. The coating platform of claim 20, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).

23. The coating platform of claim 20, wherein said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate.

24. The coating platform of claim 22, wherein said cationic polymer is chitosan.

25. The coating platform of claim 23, wherein said anionic polymer is alginate, dextran sulfate, or sulfonated lignin.

26. The coating platform of claim 21, wherein said stabilizing agent is selected from a pH regulator, a non-ionic surfactant and a crosslinker agent.

27. The coating platform of claim 26, wherein said pH regulator is selected from Phosphate buffer saline (PBS), ammonium buffer, acetate buffer, citrate buffer, and carbonate buffer.

28. The coating platform of claim 26, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.

29. The coating platform of claim 26, wherein said crosslinker agent is selected from Genipin, calcium chloride, tripolyphosphate, proanthocyanidins, epigallocatechin gallate, and glucosaminoglycans.

30. The coating platform of claim 20, wherein said agricultural agent is an agrochemical, a biologically active agent, or an agricultural product.

31. The coating platform of claim 30, wherein said agrochemical or said biologically active agent is loaded into a microparticle.

32. The coating platform of claim 31, wherein said microparticle comprises a minicell or a colloidal carrier.

33. The coating platform of claim 32, wherein said colloidal carrier is selected from a liposome, a noisome, a microsphere, a nanosphere, and an emulsion.

34. The coating platform of claim 30, wherein said agricultural product is selected from a seed, a grain, a fruit, a seedling, a leafy vegetable, a fresh-cut plant produce, and an edible part of a plant.

35. The coating platform of claim 20, wherein said layer-by-layer assembly comprises at least 3, 4, 5, 6, or more layers.

36. The coating platform of any one of claims 20-35, wherein said coating platform forms a macromolecular structure.

37. The coating platform of claim 36, wherein said macromolecular structure is a thin film, a nanoparticle, a molecular aggregate, a colloidal suspension, or a microcapsule.

38. The coating platform of any one of claims 20-37, wherein the platform is in the form of an emulsion, a film, a spray coating, a dip coating, a dissolution, or a combination thereof.

39. A multilayered biopolymer composition for agricultural use, comprising:
a. a first biopolymer which is chitosan,
b. a second biopolymer which is alginate, dextran sulfate, or sulfonated lignin,
wherein said two biopolymers are assembled by a noncovalent bond, and
wherein said composition comprises an agricultural agent within the composition.

40. The multilayered biopolymer composition of claim 39, wherein said molecule is stabilized by an addition of a stabilizing agent.

41. The multilayered biopolymer composition of claim 40, wherein said stabilizing agent is selected from a pH regulator, a non-ionic surfactant and a crosslinker agent.

42. The multilayered biopolymer composition of claim 41, wherein said pH regulator is selected from Phosphate buffer saline (PBS), ammonium buffer, acetate buffer, citrate buffer, and carbonate buffer.

43. The multilayered biopolymer composition of claim 41, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and tween®.

44. The multilayered biopolymer composition of claim 41, wherein said crosslinker agent is selected from Genipin, calcium chloride, tripolyphosphate, proanthocyanidins, epigallocatechin gallate, and glucosaminoglycans.

45. The multilayered biopolymer composition of claim 39, wherein said agricultural agent is an agrochemical, a biologically active agent, or an agricultural product.

46. The multilayered biopolymer composition of claim 45, wherein said agrochemical or said biologically active agent is loaded into a microparticle.

47. The multilayered biopolymer composition of claim 46, wherein said microparticle comprises a minicell or a colloidal carrier.

48. The multilayered biopolymer composition of claim 47, wherein said colloidal carrier is selected from a liposome, a noisome, a microsphere, a nanosphere, and an emulsion.

49. The multilayered biopolymer composition of claim 45, wherein said agricultural product is selected from a seed, a grain, a fruit, a seedling, a leafy vegetable, a fresh-cut plant produce, and an edible part of a plant.

50. The multilayered biopolymer composition of claim 39, wherein said multilayered biopolymer molecule comprises at least 2, 3, 4, 5, 6, or more layers.

51. The multilayered biopolymer composition of any one of claims 39-50, wherein said coating platform forms a macromolecular structure.

52. The multilayered biopolymer composition of claim 51, wherein said macromolecular structure is a thin film, a nanoparticle, a molecular aggregate, a colloidal suspension, or a microcapsule.

53. The multilayered biopolymer composition of any one of claims 39-52, wherein the composition is in the form of an emulsion, a film, a spray coating, a dip coating, a dissolution, or a combination thereof.

54. A composition comprising an agricultural agent coated by a layer-by-layer assembly comprising at least two biopolymers.

55. The composition of claim 54, wherein said two biopolymers are selected from chitosan, alginate, dextran, dextran sulfate, lignin, sulfonated lignin, collagen, fibrinogen, gelatin, heparin, chondroitin, fibronectin, laminin, whey protein isolate (WPI), soy protein isolate, corn protein, mucin, rice protein, wheat protein, milk protein, wheat gluten, pectin, sucrose ester, lipid, gum, cellulose, cellulose-based polymers, starch, starch-based polymer, hyaluronic acid, hydroxypropyl methyl cellulose (HPMC), Poly lactic acid (PLA), Poly Lactic-co-Glycolic Acid (PLGA), Polyglycolic acid (PGA), Polyhydroxybutyrate (PHB), Polypropylene fumarate (PPF), Poly(ethylene oxide) (PEO), Poly(ethylene glycol) (PEG), Polyurethane (PU), Polyvinyl alcohol (PVA), Polypropylene carbonate (PPC), Polydioxanone (PDO), Polycaprolactone (PCL), polyanhydrides, polyester, polyphosphoesters, polyphosphazenes, polyhydroxybutyric acids (PHB), and combinations thereof.

56. The composition of claim 54, wherein said biopolymer-coated agricultural agent is generated by a process comprising use of said layer-by-layer assembly of said at least two biopolymers onto said agricultural agent.

57. The composition of claim 55, wherein said at least two biopolymers comprise chitosan and alginate.

58. The composition of claim 55, wherein said at least two biopolymers comprise chitosan and dextran sulfate.

59. The composition of any one of claims 54-58, wherein said layer-by-layer assembly is formed by noncovalent bond.

60. The composition of claim 54, wherein said agricultural agent is an agrochemical, a biologically active agent, or an agricultural product.

61. The composition of claim 60, wherein said agrochemical or said biologically active agent is loaded into a microparticle.

62. The composition of claim 61, wherein said microparticle comprises a minicell or a colloidal carrier.

63. The composition of claim 62, wherein said colloidal carrier is selected from a liposome, a noisome, a microsphere, a nanosphere, and an emulsion.

64. The composition of claim 60, wherein said agricultural product is selected from a seed, a grain, a fruit, a seedling, a leafy vegetable, a fresh-cut plant produce, and an edible part of a plant.

65. A method of preparing a multilayered polymer composition for encapsulation and delivery of an agricultural agent, said method comprising the steps of:
a) providing a pair of polymers, wherein a first polymer comprises a cationic polymer and a second polymer comprises an anionic polymer;
b) allowing layer-by-layer assembly of said first polymer and said second polymer;
c) optionally, adding a stabilizing agent to said layer-by-layer assembly; and
d) coating the agricultural agent with said layer-by-layer assembly;
wherein said two polymers are assembled by a noncovalent bond.

66. The method of claim 65, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).

67. The method of claim 65, wherein said anionic polymer is selected from alginate, hyaluronic acid, heparin, heparan sulfate, chondroitin sulfate, dextran sulfate, sulfonated lignin, poly(meth)acrylic acid, oxidized cellulose, carboxymethyl cellulose, polyaspartic acid, polyglutamic acid, polyacrylic acid, alginic acid, and polystyrenesulfonate.

68. The method of claim 66, wherein said cationic polymer comprise chitosan.

69. The method of claim 67, wherein said anionic polymer comprise alginate, dextran sulfate, or sulfonated lignin.

70. The method of claim 65, wherein said stabilizing agent is selected from a pH regulator, a non-ionic surfactant and a crosslinker agent.

71. The method of claim 70, wherein said pH regulator is selected from Phosphate buffer saline (PBS), ammonium buffer, acetate buffer, citrate buffer, and carbonate buffer.

72. The method of claim 70, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.

73. The method of claim 70, wherein said crosslinker agent is selected from Genipin, calcium chloride, tripolyphosphate, proanthocyanidins, epigallocatechin gallate, and glucosaminoglycans.

74. The method of claim 65, wherein said agricultural agent is an agrochemical, a biologically active agent, or an agricultural product.

75. The method of claim 74, wherein said agrochemical or said biologically active agent is loaded into a microparticle.

76. The method of claim 75, wherein said microparticle comprises a minicell or a colloidal carrier.

77. The method of claim 76, wherein said colloidal carrier is selected from a liposome, a noisome, a microsphere, a nanosphere, and an emulsion.

78. The method of claim 74, wherein said agricultural product is selected from a seed, a grain, a fruit, a seedling, a leafy vegetable, a fresh-cut plant produce, and an edible part of a plant.

79. The method of claim 65, wherein said multilayered polymer composition comprises at least 2, 3, 4, 5, 6, or more layers.

80. The method of claim 65, wherein the coating of the agricultural agent with the layer-by-layer assembly increases stability of the agricultural agent from an environmental hazard.

81. The method of claim 65, wherein the coating of the agricultural agent with the layer-by-layer assembly promotes controlled release of the agricultural agent.

82. The method of claim 74 or 78, wherein said polymer-coated agricultural agent enhances a shelf-life of the agricultural product.

83. A method of producing a polymer-coated agricultural agent, the method comprising the steps of:
a) providing an agricultural agent;
b) contacting said agricultural agent with a cationic polymer;
c) contacting said agricultural agent with an anionic polymer;
thereby producing said polymer-coated agricultural agent.

84. The method of claim 83, further comprising the step of: d) adding a stabilizing agent to said polymer-coated agricultural agent.

85. The method of claim 83, wherein steps b) and c) are repeated to encapsulate said agricultural agent with a multilayer of said polymers.

86. The method of claim 83, wherein said cationic polymer is selected from chitosan, poly(allylamine hydrochloride) (PAH), polyl-lysine (PLL), poly(ethylene imine) (PEI), poly(histidine), poly(N,N-dimethyl aminoacrylate), poly(N,N,N-trimethylaminoacrylate chloride), and poly(methyacrylamidopropyltrimethyl ammonium chloride).

87. The method of claim 83, wherein said anionic polymer is selected from alginate, hyaluronic acid, heparin, heparan sulfate, chondroitin sulfate, dextran sulfate, sulfonated lignin,poly(meth)acrylic acid, oxidized cellulose, carboxymethyl cellulose, polyaspartic acid, polyglutamic acid, polyacrylic acid, alginic acid, and polystyrenesulfonate.

88. The method of claim 86, wherein said cationic polymer comprise chitosan.

89. The method of claim 87, wherein said anionic polymer comprise alginate, dextran sulfate, or sulfonated lignin.

90. The method of claim 84, wherein said stabilizing agent is selected from a pH regulator, a non-ionic surfactant and a crosslinker agent.

91. The method of claim 90, wherein said pH regulator is selected from Phosphate buffer saline (PB S), ammonium buffer, acetate buffer, citrate buffer, and carbonate buffer.

92. The method of claim 90, wherein said non-ionic surfactant is selected from Poloxamer, polysorbate, stearyl alcohol, PEG-10 sunflower glycerides, nonoxynol, lauryl glucoside, maltosides, cetyl alcohol, cocamide DEA, decyl glucoside, glycerol monostearate, alkyl polyglycoside, mycosubtilin, and Tween®.

93. The method of claim 90, wherein said crosslinker agent is selected from Genipin, calcium chloride, tripolyphosphate, proanthocyanidins, epigallocatechin gallate, and glucosaminoglycans.

94. The method of claim 83, wherein said agricultural agent is an agrochemical, a biologically active agent, or an agricultural product.

95. The method of claim 94, wherein said agrochemical or said biologically active agent is loaded into a microparticle.

96. The method of claim 95, wherein said microparticle comprises a minicell or a colloidal carrier.

97. The method of claim 96, wherein said colloidal carrier is selected from a liposome, a noisome, a microsphere, a nanosphere, and an emulsion.

98. The method of claim 94, wherein said agricultural product is selected from a seed, a grain, a fruit, a seedling, a leafy vegetable, a fresh-cut plant produce, and an edible part of a plant.

99. The method of claim 85, wherein said multilayer comprises at least 2, 3, 4, 5, 6, or more layers.

100. The method of claim 83, wherein said polymer-coated agricultural agent has increased stability from an environmental hazard when compared to an agricultural agent not encapsulated by a multilayer of said polymers.

101. The method of claim 83, wherein said polymer-coated agricultural agent is released in a controlled manner.

102. The method of claim 94 or 98, wherein said polymer-coated agricultural agent enhances a shelf-life of the agricultural product.
